(19) United States
(12) Patent Application Publication
(10) Pub. No.: US 2019/0044118 A1
(43) Pub. Date: Feb. 7, 2019

(54) SEPARATOR FOR NON-AQUEOUS SECONDARY BATTERY AND NON-AQUEOUS SECONDARY BATTERY

(71) Applicant: TEIJIN LIMITED, Osaka (JP)

(72) Inventors: Hiroshi SAKURAI, Osaka-shi (JP); Satoshi NISHIKAWA, Osaka-shi (JP); Tetsuya AKAMATSU, Osaka-shi (JP)

(73) Assignee: TEIJIN LIMITED, Osaka (JP)

(21) Appl. No.: 16/044,585

(22) Filed: Jul. 25, 2018

(30) Foreign Application Priority Data
Aug. 3, 2017 (JP) 2017-150924
Aug. 3, 2017 (JP) 2017-150925
Aug. 3, 2017 (JP) 2017-150926

(51) Int. Cl. H01M 2/16; H01M 2/14; H01M 4/62; H01M 10/0525; H01M 4/13

(52) U.S. Cl. CPC H01M 2/1626; H01M 2/145; H01M 2004/027; H01M 10/0525; H01M 4/13; H01M 4/624

(57) ABSTRACT

A separator for a non-aqueous secondary battery that is composed of a composite membrane containing a porous substrate, and a heat-resistant adhesive porous layer provided on one side or both sides of the porous substrate, in which the heat-resistant adhesive porous layer contains an acrylic type resin, and a heat-resistant resin that has a glass transition temperature of 200° C. or more and that has an amide-structure.

### CROSS-REFERENCE TO RELATED APPLICATIONS

This application claims priority under 35 USC 119 from Japanese Patent Application No. 2017-150924 filed on Aug. 3, 2017, Japanese Patent Application No. 2017-150925 filed on Aug. 3, 2017, and Japanese Patent Application No. 2017-150926 filed on Aug. 3, 2017, the disclosures of which are incorporated by reference herein.

### BACKGROUND

### Technical Field

The present invention relates to a separator for a non-aqueous secondary battery and a non-aqueous secondary battery.

### Related Art

Non-aqueous secondary batteries, which are represented by lithium ion secondary batteries, are widely used as mobile power sources for portable electronic devices such as notebook-size personal computers, mobile phones, digital cameras and camcorders, in terms of having a high energy density. Separators have significant roles in ensuring the safety of lithium ion secondary batteries and, from the viewpoint of having high strength and exhibiting shut-down function, polyethylene microporous membranes have been used. However, with the acceleration of high energy density every year, it is desired that a separator has a heat-resistant property so as to secure stability.

From the viewpoint of securing stability under high temperature, a separator having a porous substrate composed of polyolefine and a heat-resistant porous layer in which a heat-resistant resin such as a wholly aromatic polyamide is formed on the porous substrate has been proposed (for example, see Japanese Patent Nos. 4291392 and 4364940).

Further, outer packaging of non-aqueous secondary batteries has been simplified and lightened with size reduction and weight reduction of portable electronic devices, and as outer packaging materials, aluminum cans have been developed in place of stainless-steel cans, and further, aluminum laminated film packages have been developed in place of metallic cans. However, an aluminum laminated film package is soft, and therefore in a battery having the aforementioned package as an outer packaging material (a so called soft package battery), a gap is easily formed between an electrode and a separator due to external impact, or electrode expansion and shrinkage associated with charge-discharge, which may cause the reduction of the cycle life of the battery and, in a worst-case scenario, a short-circuit may take place between the electrodes which causes an ignition accident. Accordingly, techniques for improving adhesion between an electrode and a separator have been demanded.

As one of the techniques, a separator having a porous layer containing a polyvinylidene fluoride type resin on a porous substrate has been proposed (see, for example, Japanese Patent No. 4127989).

### SUMMARY OF INVENTION

### Technical Problem

However, in the related art such as Japanese Patent Nos. 4291392 and 4364940, since the heat-resistant resin such as wholly aromatic polyamide does not express adhesion to an electrode, it is impossible to adhere the separator and the electrode to each other. In addition, in the separator disclosed in the above-described Japanese Patent No. 4127989, the glass transition temperature of the polyvinylidene fluoride type resin is low, so that heat resistance may not be sufficient. That is, the conventional separators as disclosed in Japanese Patent Nos. 4291392, 4364940 and 4127989 do not have both functions of heat resistance and adhesion to the electrode. In a soft pack battery having higher energy density, the separator having both heat resistance and adhesion becomes important, for increasing stability at high temperature and a cycle life of the battery.

A laminated body with a separator disposed between a positive electrode and a negative electrode may be subjected to dry heat press (heat press treatment performed without impregnating a separator with an electrolytic solution) in production of a battery. If a separator favorably adheres to an electrode with each other by dry heat press, it is possible to improve a battery production yield. Thus, a separator having an excellent function of adhering to an electrode by a dry heat press (hereinafter, referred to as dry adhesion) is desired.

In addition, even in the case of adhering the electrode and the separator by the dry heat press, when an electrolyte solution is impregnated, the electrode and the separator may be separated. In this case, due to external shock, or expansion and shrinkage of the electrode involved in charge and discharge, a short-circuit occurs between the electrodes in the worst case, leading to an ignition accident. Thus, the separator having an excellent function of adhering to an electrode by heat press treatment after impregnating the separator with the electrolyte solution (hereinafter, referred to as wet adhesion) is also desired.

Here, it may be considered to obtain a separator having both heat resistance and dry adhesion, or a separator having all of heat resistance and dry and wet adhesion, by combining a heat-resistant resin such as aromatic polyamide and a polyvinylidene fluoride type resin. However, there is an affinity between the resins, and even in the case of simply combining resins having different functions, a practical separator cannot be always obtained. For example, since aromatic polyamide and a polyvinylidene fluoride type resin have a poor affinity with each other, when mixing these resins and coating the mixture on a substrate to obtain a composite membrane, a coated film is easily peeled off from the substrate, or the coated film itself is brittle to have deteriorated handling characteristics. In addition, for example, when a heat-resistant layer including aromatic polyamide is formed on a porous substrate, and an adhesive layer including a polyvinylidene fluoride type resin is further formed on this heat-resistant layer to obtain a composite membrane, the adhesive layer is easily peeled off from the heat-resistant layer to have deteriorated handling characteristics. Thus, it is necessary to design the separator considering the affinity between the resins or the handling characteristics.

In view of the above background, an object of a first embodiment of the present invention is to provide a separator having both heat resistance and dry adhesion, and also having excellent handling characteristics, and to solve this object.

In addition, an object of a second embodiment of the present invention is to provide a separator having all of heat resistance, dry adhesion and wet adhesion, and also having excellent handling characteristics, and to solve this object.

### Solution to Problem

Specific means for solving the above problem include the following aspects.

[1] A separator for a non-aqueous secondary battery that is composed of a composite membrane, the composite membrane comprising a porous substrate, and a heat-resistant adhesive porous layer provided on one side or both sides of the porous substrate, wherein the heat-resistant adhesive porous layer contains an acrylic type resin, and a heat-resistant resin that has a glass transition temperature of 200° C. or more and that has an amide-structure.
[2] The separator for a non-aqueous secondary battery according to the above [1], wherein the heat-resistant adhesive porous layer has a structure in which the acrylic type resin having a particle configuration with a size of from 10 nm to 500 nm is dispersed in a porous structure of the heat-resistant resin.
[3] The separator for a non-aqueous secondary battery according to above [2], wherein a glass transition temperature of the acrylic type resin is from 0° C. to 80° C.
[4] The separator for a non-aqueous secondary battery according to above [1], wherein the heat-resistant adhesive porous layer has a structure in which a surface of the porous structure of the heat-resistant resin and/or inside surface of pores of the porous structure of the heat-resistant resin is coated with the acrylic type resin.
[5] The separator for a non-aqueous secondary battery according to above [4], wherein a glass transition temperature of the acrylic type resin is less than 0° C.
[6] The separator for a non-aqueous secondary battery according to any one of the above [1] to [5], wherein the heat-resistant resin is one or more selected from the group consisting of a polyamide imide, a wholly aromatic polyamide, a poly-N-vinylacetamide, a polyacrylamide and a polyetheramide copolymer.
[7] The separator for a non-aqueous secondary battery according to any one of the above [1] to [5], wherein the heat-resistant resin is a para-wholly aromatic polyamide.
[8] The separator for a non-aqueous secondary battery according to any one of the above [1] to [7], wherein a content of the acrylic type resin in the heat-resistant adhesive porous layer is from 5 to 60% by mass with respect to a total mass of the acrylic type resin and the heat-resistant resin.
[9] The separator for a non-aqueous secondary battery according to above [1], wherein the heat-resistant adhesive porous layer further contains a polyvinylidene fluoride type resin.
[10] The separator for a non-aqueous secondary battery according to above [9], wherein the heat-resistant resin is one or more selected from the group consisting of a polyamide imide, a wholly aromatic polyamide, a poly-N-vinylacetamide, a polyacrylamide and a polyetheramide copolymer.
[11] The separator for a non-aqueous secondary battery according to above [9], wherein the heat-resistant resin is a para-wholly aromatic polyamide.
[12] The separator for a non-aqueous secondary battery according to any one of the above [9] to [11], wherein the acrylic type resin is a copolymer containing an acrylic type monomer and a styrene type monomer as monomer components.
[13] The separator for a non-aqueous secondary battery according to any one of the above [9] to [12], wherein the polyvinylidene fluoride type resin is a copolymer containing vinylidene fluoride and hexafluoropropylene as monomer components, a content of the hexafluoropropylene monomer component in the copolymer is from 3 to 20% by mass, and a weight average molecular weight of the copolymer is from 100,000 to 1,500,000.
[14] The separator for a non-aqueous secondary battery according to any one of the above [9] to [13], wherein a content of the polyvinylidene fluoride type resin in the heat-resistant adhesive porous layer is from 5 to 55% by mass with respect to a total mass of the acrylic type resin and the polyvinylidene fluoride type resin.
[15] The separator for a non-aqueous secondary battery according to any one of the above [9] to [14], wherein, in the heat-resistant adhesive porous layer, a content of the heat-resistant resin is from 30 to 80% by mass, a content of the acrylic type resin is from 10 to 40% by mass, and a content of the polyvinylidene fluoride type resin is from 10 to 30% by mass, with respect to a total mass of the heat-resistant resin, the acrylic type resin and the polyvinylidene fluoride type resin.
[16] The separator for a non-aqueous secondary battery according to any one of the above [9] to [15], wherein the heat-resistant adhesive porous layer has a structure in which a mixture that has a particle configuration with a size of from 10 nm to 500 nm and that is composed of the acrylic type resin and the polyvinylidene fluoride type resin is dispersed in a porous structure of the heat-resistant resin.
[17] The separator for a non-aqueous secondary battery according to any one of the above [9] to [15], wherein the heat-resistant adhesive porous layer has a structure in which a surface of the porous structure of the heat-resistant resin and/or inside surface of pores of the porous structure of the heat-resistant resin is coated with a mixture of the acrylic type resin and the polyvinylidene fluoride type resin.
[18] The separator for a non-aqueous secondary battery according to any one of the above [1] to [17], wherein the heat-resistant adhesive porous layer contains a filler in an amount of from 5 to 80% by mass with respect to a total mass of the heat-resistant adhesive porous layer.
[19] The separator for a non-aqueous secondary battery according to any one of the above [1] to [18], wherein an adhesive porous layer containing a polyvinylidene fluoride type resin is further provided on one side or both sides of the composite membrane.
[20] A non-aqueous secondary battery, comprising:
a positive electrode,
a negative electrode, and
the separator for a non-aqueous secondary battery according to any one of the above [1] to [19], disposed between the positive electrode and the negative electrode, wherein an electromotive force is obtained by lithium doping and dedoping.

### Advantageous Effect of the Invention

According to the first embodiment of the present invention, a separator having both heat resistance and dry adhesion, and also having excellent handling characteristics can be provided.

In addition, according to the second embodiment of the present invention, a separator having all of heat resistance, dry adhesion and wet adhesion, and also having excellent handling characteristics can be provided.

### DESCRIPTION OF EMBODIMENTS

Hereinafter, the embodiments of the present disclosure will be described. Note that the following explanation and examples merely illustrate the invention and are not intended to limit the scope of the invention. Unless otherwise noted, the terms “the present disclosure”, “in the present specification” and “of the present invention” include both the first and second embodiments.

Further, in the present disclosure, the numerical range indicated by “to” refers to a range including respective values presented before and after “to” as a minimum and a maximum, respectively.

In the present disclosure, the term “step” refers not only to an independent step, but also to a step that cannot be clearly distinguished from other steps as long as an expected object of the step is achieved.

When the amount of each component in a composition is mentioned in the present disclosure, the amount, when there exist a plurality of substances corresponding to each component in the composition, means the total amount of the plurality of substances existing in the composition unless otherwise specified.

In the present disclosure, the term “machine direction” means a longitudinal direction of a porous substrate and a separator that are produced into a long shape, and the term “width direction” means a direction perpendicular to the “machine direction”. In the present disclosure, the term “machine direction” is also referred to as a “MD direction”, and the term “width direction” is also referred to as a “TD direction”.

In the present specification, the term “monomer component” of a copolymer means a constituent component of the copolymer, which is a constituent unit obtained by polymerizing monomers.

### Separator for a Non-Aqueous Secondary Battery According to First Embodiment

A separator for a non-aqueous secondary battery (also referred to as a “separator”) according to first embodiment of the present disclosure is composed of a composite membrane including a porous substrate, and a heat-resistant adhesive porous layer provided on one side or both sides of the porous substrate, wherein the heat-resistant adhesive porous layer contains an acrylic type resin, and a heat-resistant resin that has a glass transition temperature of 200° C. or more and that has an amide-structure.

The separator of the first embodiment of the present disclosure has both heat resistance and dry adhesion, and also has excellent handling characteristics.

Specifically, a heat-resistant resin that has a glass transition temperature of 200° C. or more and that has an amide-structure improves stability at high temperature, thereby for example, reducing thermal shrinkage of the separator at 175° C. In addition, since an acrylic type resin increases adhesion to an electrode by a dry heat press, it becomes difficult to misalign the position of the electrode in the manufacturing process of a battery, thereby improving a manufacturing yield of the battery. In addition, the separator and the electrode are well adhered to each other, thereby improving cycle characteristics (capacity retention ratio) of the battery. In addition, due to external impact, or expansion and shrinkage of the electrode involved in charge and discharge, a gap is hardly formed between the electrode and the separator, thereby significantly suppressing a firing accident due to a short-circuit between the electrodes.

In addition, in the first embodiment of the present disclosure, since the affinity between the acryl group of the acrylic type resin and the amide bond of the heat-resistant resin is high, the heat-resistant resin and the acrylic type resin are bonded to each other in a heat-resistant adhesive porous layer, so that it is difficult for the heat-resistant adhesive porous layer to be peeled off from a porous substrate, and heat-resistant adhesive porous layer also maintains a porous structure well, and thus, handling characteristics are excellent.

### Separator for a Non-Aqueous Secondary Battery According to Second Embodiment

A separator for a non-aqueous secondary battery (also referred to as a “separator”) according to second embodiment of the present disclosure is composed of a composite membrane including a porous substrate, and a heat-resistant adhesive porous layer provided on one side or both sides of the porous substrate, wherein the heat-resistant adhesive porous layer contains an acrylic type resin, a polyvinylidene fluoride type resin, and a heat-resistant resin that has a glass transition temperature of 200° C. or more and that has an amide-structure.

The separator of the second embodiment of the present disclosure has all of heat resistance, dry adhesion and wet adhesion, and also has excellent handling characteristics.

Specifically, a heat-resistant resin that has a glass transition temperature of 200° C. or more and that has an amide-structure improves stability at high temperature, thereby for example, reducing thermal shrinkage of the separator at 150° C. In addition, since an acrylic type resin and a polyvinylidene fluoride type resin increase adhesion to an electrode by a dry heat press and a wet heat press, it becomes difficult to misalign the position of the electrode in the manufacturing process of a battery, thereby not only improving a manufacturing yield of the battery but also improving cycle characteristics (capacity retention ratio) of the battery by securing adhesion to the electrode even after impregnation with the electrolyte solution. In addition, due to external impact, or expansion and shrinkage of the electrode involved in charge and discharge, a gap is hardly formed between the electrode and the separator, thereby significantly suppressing a firing accident due to a short-circuit between the electrodes.

In addition, in the second embodiment of the present disclosure, since the acrylic type resin serves as a compatibilizing agent for the heat-resistant resin and the polyvinylidene fluoride type resin, thereby a clear solution in which these three resins are uniformly mixed with each other on the molecular level is formed. Therefore, the heat-resistant resin, the acrylic type resin and the polyvinylidene fluoride type resin are bonded to each other in a heat-resistant adhesive porous layer, so that it is difficult for the heat-resistant adhesive porous layer to be peeled off from a porous substrate, and heat-resistant adhesive porous layer also maintains a porous structure well, and thus, handling characteristics are excellent.

Hereinafter, each of the elements of the separator of the present disclosure will be described in detail.

[Porous Substrate]

In the present disclosure, the porous substrate means a substrate having voids or gaps therein. The porous substrate is, for example, a microporous membrane; a porous sheet made of a fibrous material such as a non-woven fabric or paper. The porous substrate is preferably a microporous membrane from the viewpoint of thinning and strength of a separator. The microporous membrane means a membrane which has many micropores therein and has a structure in which micropores are mutually connected so that a gas or liquid can pass from one surface to the other.

The material of the porous substrate is preferably a material having electrical insulation and may be an organic material and/or an inorganic material.

The porous substrate preferably contains a thermoplastic resin from the viewpoint of imparting a shut-down function to the porous substrate. The term “shut-down function” refers to the following function: in a case in which the battery temperature increases, the composition material melts and blocks the pores of the porous substrate, thereby blocking the movement of ions to suppress the thermal runaway of the battery. The thermoplastic resin is preferably a thermoplastic resin having a melting point of less than 200° C. Examples of the thermoplastic resin include polyesters such as polyethylene terephthalate; and polyolefins such as polyethylene and polypropylene, and among them, polyolefins are preferable.

The porous substrate is preferably a microporous membrane containing a polyolefin (hereinafter, appropriately referred to as a “polyolefin microporous membrane”). Examples of the polyolefin microporous membrane include polyolefin microporous membranes that are applied to conventional battery separators, and it is preferable that one having sufficient dynamic characteristics and ion permeability is selected from these polyolefin microporous membranes.

Preferably, the polyolefin microporous membrane contains polyethylene from the viewpoint of exhibiting a shut-down function. The content of polyethylene is preferably 95% by mass or more with respect to a total mass of the polyolefin microporous membrane.

The polyolefin microporous membrane preferably contains polypropylene from the viewpoint of imparting heat resistance which prevents the membrane from easily breaking in a case of being exposed to a high temperature. An example of such a polyolefin microporous membrane containing polypropylene is a microporous membrane in which a content of polypropylene is 30% by mass or more with respect to a total mass of the microporous membrane. Another example is a microporous membrane in which polyethylene and polypropylene coexist in one layer. In such a microporous membrane, it is preferable that polypropylene is contained in an amount of from 0.1% by mass to 30% by mass with respect to a total mass of the microporous membrane, from the viewpoint of achieving both shut-down function and heat resistance. From the viewpoint of achieving both shut-down function and heat resistance, a polyolefin microporous membrane having a laminate structure of two or more layers, in which at least one layer includes polyethylene and at least one layer includes polypropylene, is also preferable. In particular, a polyolefin microporous membrane having a laminate structure of two or more layers, in which at least one layer includes polyethylene and at least one layer includes polyolefin. Even in the case of using this polyolefin microporous membrane including polypropylene as the porous substrate of the separator of the present disclosure, the heat-resistant adhesive porous layer is closely well adhered on a substrate including polypropylene, thereby securing sufficient peeling strength. Conventionally, the heat-resistant resin such as wholly aromatic polyamide has a poor affinity with polypropylene, so that the heat-resistant resin layer is easily peeled off from the polypropylene layer. However, in the first embodiment of the present disclosure, the acrylic type resin serves to secure peeling strength between the two layers, thereby capable of securing good handling characteristics, and obtaining a separator having better heat resistance. In addition, in the second embodiment of the present disclosure, the acrylic type resin and the polyvinylidene fluoride type resin serve to secure peeling strength between the two layers, thereby capable of securing good handling characteristics, and obtaining a separator having better heat resistance.

The weight average molecular weight (Mw) of polyolefin contained in the polyolefin microporous membrane is preferably from 100,000 to 5,000,000. When the Mw of the polyolefin is 100,000 or more, it is possible to ensure favorable dynamic characteristics for a microporous membrane. Meanwhile, when the Mw of the polyolefin is 5,000,000 or less, shut-down characteristics are favorable and it is easy to mold a microporous membrane.

Examples of the method of producing a polyolefin microporous membrane include a method of forming a microporous membrane including: extruding a molten polyolefin resin from a T-die to form the resin into a sheet; crystallizing the sheet; stretching the resulting sheet; and heat-treating the sheet, or a method of forming a microporous membrane including: extruding a polyolefin resin molten together with a plasticizer such as liquid paraffin from a T-die; cooling the extruded resin to form into a sheet; stretching the sheet; extracting the plasticizer; and heat-treating the resulting sheet to form a microporous membrane.

Examples of the porous sheet made of a fibrous material include a porous sheet of non-woven fabrics or a paper, which are made of fibrous materials such as polyester (e.g., polyethylene terephthalate); polyolefin (e.g., polyethylene and polypropylene); and a heat resistant resin (e.g., aromatic polyamide, polyimide, polyether sulfone, polysulfone, polyether ketone and polyether imide).

In order to improve wettability with a coating liquid for forming a porous layer, a surface of the porous substrate may be subjected to various kinds of surface treatments as long as the properties of the porous substrate are not impaired. Examples of the surface treatment include a corona treatment, a plasma treatment, a flame treatment and an ultraviolet ray irradiation treatment.

[Characteristics of Porous Substrate]

In the present disclosure, the thickness of the porous substrate is preferably from 5 μm to 25 μm from the viewpoint of obtaining favorable dynamic characteristics and internal resistance.

The Gurley value (JIS P8117: 2009) of the porous substrate is preferably in a range of from 50 sec/100 cc to 300 sec/100 cc from the viewpoint of suppressing the short circuit of a battery and obtaining sufficient ion permeability.

The porosity of the porous substrate is preferably from 20% to 60% from the viewpoint of obtaining suitable membrane resistance and a suitable shut-down function. The porosity of the porous substrate is determined in accordance with the following calculation method. Where constituent materials are a, b, c, . . . n; the masses of each of the constituent materials are Wa, Wb, Wc, . . . , Wn (g/cm²); the true densities of each of the constituent materials are da, db, dc, . . . , dn (g/cm³), and the thickness is t (cm), the porosity ε (%) is determined by the following formula.

ε={1−(Wa/da+Wb/db+Wc/dc+ . . . +Wn/dn)/t}×100

The puncture strength of the porous substrate is preferably 300 g or more from the viewpoint of improving the separator production yield and the battery production yield. The puncture strength of the porous substrate is a maximum puncture load (g) measured by conducting a puncture test under the condition of a needle tip curvature of 0.5 mm and a puncture speed of 2 mm/sec by using a KES-G 5 handy compression tester manufactured by Kato Tech Co., Ltd.

[Heat-Resistant Adhesive Porous Layer]

In the present disclosure, the heat-resistant adhesive porous layer is a layer that is provided on one side or both sides of a porous substrate, and is able to adhered to an electrode at the time when the separator and the electrode are superposed on each other, and pressed or hot-pressed.

In the present disclosure, the heat-resistant adhesive porous layer has a large number of micropores therein, with the micropores being linked together, and allows a gas or liquid to pass from one surface to the other surface. As this heat-resistant adhesive porous layer, the following two types are preferred, but in the present disclosure, the porous structure is not particularly limited, as long as it is a porous layer including the heat-resistant resin and the acrylic type resin, or a porous layer including the heat-resistant resin, the acrylic type resin and the polyvinylidene fluoride type resin.

(1) Type A: the heat-resistant adhesive porous layer has a structure in which the acrylic type resin that has a particle configuration with a size of from 10 nm to 500 nm is dispersed in a porous structure composed of the heat-resistant resin, or the heat-resistant adhesive porous layer has a structure in which a mixture that has a particle configuration with a size of from 10 nm to 500 nm and that is composed of the acrylic type resin and the polyvinylidene fluoride type resin, is dispersed in a porous structure composed of the heat-resistant resin. Specifically, it is preferred to have a structure in which the heat-resistant resin forms a fibril-shaped body, a plurality of these fibril-shaped bodies are integrally connected to form a three-dimensional network structure, and the acrylic type resin that has a particle configuration with a size of from 10 nm to 500 nm, or the mixture that has a particle configuration with a size of from 10 nm to 500 nm and that is composed of the acrylic type resin and the polyvinylidene fluoride type resin is dispersed in this three-dimensional network structure. This porous structure can be confirmed by, for example, a scanning electron microscope (SEM), and the like.

In the heat-resistant adhesive porous layer of type A, when a particle size of the acrylic type resin, or a particle size of the mixture of the acrylic type resin and the polyvinylidene fluoride type resin is 500 nm or less, permeability is good. From this point of view, a particle size of the acrylic type resin, or a particle size of the mixture of the acrylic type resin and the polyvinylidene fluoride type resin is preferably 200 nm or less, and more preferably 100 nm or less. Meanwhile, when a particle size of the acrylic type resin, or a particle size of the mixture of the acrylic type resin and the polyvinylidene fluoride type resin is more than 10 nm, adhesion to an electrode is improved. From this point of view, a particle size of the acrylic type resin, or a particle size of the mixture of the acrylic type resin and the polyvinylidene fluoride type resin is preferably 20 nm or more, and more preferably 25 nm or more.

With respect to formation of the heat-resistant adhesive porous layer such as type A, it is preferred to use the acrylic type resin that has a glass transition temperature of from 0° C. to 80° C. as the acrylic type resin.

(2) Type B: the heat-resistant adhesive porous layer has a structure in which a surface of the porous structure of the heat-resistant resin and/or inside surface of pores of the porous structure composed of the heat-resistant resin is/are coated with the acrylic type resin, or the heat-resistant adhesive porous layer has a structure in which a surface of the porous structure of the heat-resistant resin and/or inside surface of pores of the porous structure composed of the heat-resistant resin is/are coated with a mixture of the acrylic type resin and the polyvinylidene fluoride type resin. Specifically, it is preferred to have a structure in which the heat-resistant resin forms a fibril-shaped body, a plurality of these fibril-shaped bodies are integrally connected to form a three-dimensional network structure, and the surface of this three-dimensional network structure and/or the inner surface of the pores of this three-dimensional network structure is/are coated with the acrylic type resin, or coated with a mixture of the acrylic type resin and the polyvinylidene fluoride type resin.

In the heat-resistant adhesive porous layer of type B, the acrylic type resin, or the mixture of the acrylic type resin and the polyvinylidene fluoride type resin may coat at least a part of the surface of the three-dimensional network structure and/or inside surface of pores of the three-dimensional network structure, however, in terms of improving adhesive strength to an electrode, it is preferred to coat 50% or more, and more preferably 80% or more of the surface and/or inside surface of pores of the three-dimensional network structure of the three-dimensional network structure. This porous structure can be confirmed by, for example, a scanning electron microscope (SEM), and the like.

With respect to formation of the heat-resistant adhesive porous layer such as type B, it is preferred to use the acrylic type resin having a glass transition temperature less than 0° C.

Preferably, the heat-resistant adhesive porous layer exists on not only one side, but on both sides of the porous substrate for the battery to have an excellent cycle characteristic. When the heat-resistant adhesive porous layer exists on both sides of the porous substrate, both sides of the separator are well adhered to both electrodes with the heat-resistant adhesive porous layer interposed therebetween. In the present disclosure, the heat-resistant adhesive porous layer may further contain other resins than the above-described acrylic type resin, the heat-resistant resin and the polyvinylidene fluoride type resin; an inorganic filler; an organic filler and the like as long as the effect of the invention is not hindered.

(Heat-Resistant Resin)

In the present disclosure, the heat-resistant resin that has a glass transition temperature of 200° C. or more and that has an amide-structure is preferably, for example, one or more selected from the group consisting of polyamideimide, wholly aromatic polyamide, poly-N-vinyl acetamide, polyacrylamide and copolymerized polyetherimide. In particular, in terms of durability, wholly aromatic polyamide (meta-aromatic polyamide, para-aromatic polyamide) is preferred, and also, in terms of easily forming the porous layer and having excellent resistance to oxidation reduction, meta-aromatic polyamide is preferred, and in particular polymetaphenylene isophthalamide is preferred.

The heat-resistant resin may be a homopolymer, and may contain a small amount of a copolymerization component depending on a desired purpose such as exhibiting flexibility. That is, for example, in the wholly aromatic polyamide, it is also possible to copolymerize for example, a small amount of aliphatic components.

In the present disclosure, the para-wholly aromatic polyamide is also preferred. The para-wholly aromatic polyamide is a polymer in which one or two or more divalent aromatic groups are directly linked by an amide bond. The aromatic group includes those in which two aromatic rings are bonded via oxygen, sulfur or an alkylene group, or those in which two or more aromatic rings are directly bonded. In addition, these two or more aromatic groups may include lower alkyl groups such as a methyl group or an ethyl group, a methoxy group, a halogen group such as a chloro group, and the like. The position of the amide bond which directly links the divalent aromatic groups is a para type.

This para-wholly aromatic polyamide is preferably one or more selected from the group consisting of, for example, poly-p-phenylene terephthalamide, or a polymer produced by copolymerizing poly-p-phenylene terephthalamide with diaminophenylene-terephthalamide. In particular, in terms of solubility in an organic solvent, a polymer produced by copolymerizing poly-p-phenylene terephthalamide with diaminophenylene-terephthalamide (TECHNORA, manufactured by TEIJIN LIMITED) is preferred.

The para-wholly aromatic polyamide may be a homopolymer, or may contain a small amount of copolymerization components depending on a desired purpose such as exhibiting flexibility. That is, for example, in the para-wholly aromatic polyamide, it is also possible to copolymerize for example, a small amount of aliphatic components.

(Acrylic Type Resin)

In the present disclosure, the acrylic type resin preferably contains at least one acrylic type monomer selected from the group consisting of an acrylic acid, an acrylic acid salt, an acrylic acid ester, a methacrylic acid, a methacrylic acid salt and a methacrylic acid ester. Examples of the acrylic acid salt include sodium acrylate, potassium acrylate, magnesium acrylate and zinc acrylate. Examples of the acrylic acid ester include methyl acrylate, ethyl acrylate, isopropyl acrylate, n-butyl acrylate, 2-ethylhexyl acrylate, lauryl acrylate, stearyl acrylate, 2-hydroxyethyl acrylate, hydroxypropyl acrylate, methoxypolyethylene glycol acrylate, isobornyl acrylate, dicyclopentanyl acrylate, cyclohexyl acrylate and 4-hydroxybutyl acrylate. Examples of the mathacrylic acid salt include sodium methacrylate, potassium methacrylate, magnesium methacrylate and zinc methacrylate. Examples of the methacrylic acid ester include methyl methacrylate, ethyl methacrylate, isopropyl methacrylate, butyl methacrylate, isobutyl methacrylate, n-hexyl methacrylate, cyclohexyl methacrylate, lauryl methacrylate, stearyl methacrylate, 2-ethylhexyl methacrylate, 2-hydroxyethyl methacrylate, hydroxypropyl methacrylate, diethylaminoethyl methacrylate, methoxypolyethylene glycol methacrylate, isobornyl methacrylate, dicyclopentanyl methacrylate, cyclohexyl methacrylate and 4-hydroxybutyl methacrylate.

Among them, methyl methacrylate, ethyl methacrylate, isopropyl methacrylate, butyl methacrylate, lauryl methacrylate, stearyl methacrylate, 2-ethylhexyl methacrylate, methyl acrylate, ethyl acrylate, isopropyl acrylate, n-butyl acrylate, 2-hydroxyethyl acrylate, 2-ethylhexyl acrylate, 2-hydroxyethyl methacrylate, lauryl acrylate and stearyl acrylate are preferable as the acrylic type monomer

In the second embodiment of the present disclosure, in particular, the acrylic type resin using methyl methacrylate as a starting raw material is preferred, since it has high compatibility with the polyvinylidene fluoride type resin, and thus the heat-resistant resin, the acrylic type resin and the polyvinylidene fluoride type resin tend to be more uniformly mixed.

The acrylic type resin may be a copolymer of the acrylic type monomer with other monomer, and as the other monomer, for example, a styrene type monomer or an unsaturated carboxylic anhydride, or the like may be mentioned.

Examples of the styrene type monomer may include styrene, meta-chlorostyrene, para-chlorostyrene, para-fluorostyrene, para-methoxystyrene, meta-tertiary-butoxystyrene, para-tertiary-butoxystyrene, para-vinylbenzoic acid, and para-methyl-α-methylstyrene.

Among them, styrene, para-methoxy-styrene and para-methyl-α-methylstyrene are preferable as the styrene type monomer, and in particular, an acrylic type resin containing a styrene unit is most preferable due to a strong effect of suppressing dissolution in an electrolytic solution. The content of the styrene type monomer contained in the acrylic type resin is preferably from 30% by mass to 90% by mass, more preferably from 40% by mass to 87% by mass, and most preferably from 50% by mass to 83% by mass.

Examples of the unsaturated carboxylic anhydride may include maleic anhydride, itaconic anhydride, citraconic anhydride, 4-methacryloxyethyltrimellitic anhydride, and trimellitic anhydride. Addition of the unsaturated carboxylic anhydride not only causes intermolecular interaction with constituents of the electrode due to the strong polarization, but also in some cases, causes an acid anhydride skeleton to react with a resin component in the electrode or with amine end of the heat-resistant resin, thereby resulting in strong adhesion.

The unsaturated carboxylic anhydride contained in the acrylic type resin is 50% by mass or less, more preferably 40% by mass or less, most preferably 30% by mass or less with respect to a total amount of the acrylic type resin. When the amount of the unsaturated carboxylic anhydride is 50% by mass or less with respect to a total amount of the acrylic type resin, the glass transition temperature of the acrylic type resin does not exceed 80° C., and it is possible to firmly adhered the separator to the electrode by dry heat press. The content of the unsaturated carboxylic anhydride contained in the acrylic type resin is preferably 1.0% by mass or more with respect to a total amount of the acrylic type resin from the viewpoint of adhesiveness. From this viewpoint, the amount of the unsaturated carboxylic anhydride is more preferably 5% by mass or more, particularly preferably 10% by mass or more.

The glass transition temperature of the acrylic type resin to be used in the present disclosure is preferably in a range of from −70° C. to 80° C. Generally, as the glass transition temperature of the acrylic type resin decreases, the fluidity of the heat-resistant adhesive porous layer is increased in dry heat press, and therefore the polymer chain enters irregularities of an electrode surface to exhibit an anchor effect, so that adhesiveness of the heat-resistant adhesive porous layer to the electrode is improved. The glass transition temperature is preferably −70° C. or higher because the heat-resistant adhesive porous layer situated on a separator surface hardly causes blocking. The glass transition temperature is preferably 80° C. or lower because the effect of adhesiveness by dry heat press is easily improved.

With respect to formation of the heat-resistant adhesive porous layer such as type A, it is preferred to use the acrylic type resin that has a glass transition temperature of from 0° C. to 80° C., and with respect to formation of type B, it is preferred to use the acrylic type resin that has a glass transition temperature less than 0° C. All of the acrylic type resins having different glass transition temperatures required for forming type A and type B can be designed by changing the copolymerization compositional ratios of a combination of the above-mentioned acrylic type monomer, styrene type monomer, unsaturated carboxylic anhydride, and the like. Specifically, after predicting the glass transition temperature of the acrylic type resin by the FOX equation, and the resistance to an electrolyte solution of the acrylic type resin, or the solubility in the organic solvent by a solubility parameter, a copolymerization compositional ratio of a combination of an acrylic type monomer, a styrene type monomer, an unsaturated carboxylic anhydride, and the like may be determined.

The weight average molecular weight (Mw) of the acrylic type resin to be used in the separator of the present disclosure is preferably from 10,000 to 500,000. The Mw of the acrylic type resin is preferably 10,000 or more because adhesive strength to the electrode by dry heat press is improved. The Mw of the acrylic type resin is preferably 500,000 or less because the heat-resistant adhesive porous layer has favorable fluidity in dry heat press. The Mw of the acrylic type resin is more preferably in a range of from 20,000 to 300,000, most preferably in a range of from 30,000 to 200,000.

In the first embodiment of the present disclosure, from the viewpoint of exhibiting the effect of the invention and increasing peeling strength between the porous substrate and the heat-resistant adhesive porous layer, the content of the acrylic type resin in the heat-resistant adhesive porous layer is preferably 5% by mass or more, more preferably 10% by mass or more, still more preferably 15% by mass or more, still more preferably 20% by mass or more with respect to a total mass of the acrylic type resin and the heat-resistant resin. From the viewpoint of suppressing cohesive fracture of the heat-resistant adhesive porous layer, the content of the acrylic type resin in the heat-resistant adhesive porous layer is preferably 60% by mass or less, more preferably 55% by mass or less, still more preferably 50% by mass or less, still more preferably 45% by mass or less with respect to a total mass of the acrylic type resin and the heat-resistant resin.

In the second embodiment of the present disclosure, it is preferred that the contents of the heat-resistant resin, the acrylic type resin and the polyvinylidene fluoride type resin in the heat-resistant adhesive porous layer are, from 30% by mass to 80% by mass of the heat-resistant resin, from 10% by mass to 40% by mass of the acrylic type resin, and from 10% by mass to 30% by mass of the polyvinylidene fluoride type resin, respectively, with respect to a total mass of the total resins contained in the heat-resistant adhesive porous layer, from the viewpoint of exhibiting the effect of the present invention and at the same time increasing the peeling strength between the porous substrate and the heat-resistant adhesive porous layer. When the heat-resistant resin is 30% by mass or more, stability at high temperature is improved, and for example, thermal shrinkage of the separator at 150° C. can be reduced. Meanwhile, when the heat-resistant resin is 80% by mass or less, in an organic solvent dissolving the acrylic type resin and the polyvinylidene fluoride type resin, those three kinds of resins can be uniformly compatibilized at a molecular level, resulting in higher peeling strength between the heat-resistant adhesive porous layer and the porous substrate interface, simultaneously with good adhesion to an electrode. A more preferred range of the content of the heat-resistant resin contained in the heat-resistant adhesive porous layer is from 42% by mass to 60% by mass. When the acrylic type resin is 10% by mass or more, sufficient adhesive strength by the dry heat press can be secured. Meanwhile, when acrylic type resin is 40% by mass or less, strong adhesion to the porous substrate can be realized. The more preferred range of the content of the acrylic type resin is from 20% by mass to 38% by mass. When the polyvinylidene fluoride type resin is 10% by mass or more, sufficient adhesive strength by the wet heat press can be secured. Meanwhile, when the polyvinylidene fluoride type resin is 30% by mass or less, excessive swelling of the heat-resistant adhesive porous layer is suppressed, so that the adhesion between the electrode and the heat-resistant adhesive porous layer within the battery is easily maintained. A more preferred range of the polyvinylidene fluoride type resin is from 12% by mass to 26% by mass.

In addition, in the heat-resistant adhesive porous layer, when the polyvinylidene fluoride type resin is contained at from 5% by mass to 55% by mass, with respect to a total mass of the acrylic type resin and the polyvinylidene fluoride type resin, the adhesive strength between the heat-resistant adhesive porous layer and the porous substrate becomes good, and also a good balanced composite membrane having dry and wet adhesion to an electrode is obtained. Though the reason is not clear, the heat-resistant resin having an amide-structure and the acrylic type resin may have a so-called, lower critical solution temperature (LCST) type phase diagram in some cases in which the resins are separated into two phases at high temperature, and become one compatibilized phase at low temperature near room temperature, in a mixed solvent of a good solvent and a phase separating agent. Meanwhile, it is known that the acrylic type resin using methyl methacrylate in the acrylic type monomer has high compatibility with the polyvinylidene fluoride type resin. In general, the affinity between the heat-resistant resin having an amide-structure and the polyvinylidene fluoride type resin is low, so that it is difficult to uniformly mix them at a molecular level. However, it is presumably because the acrylic type resin having high affinity with both of the resins serves as a compatibilizer for both of the resins, thereby allowing homogeneous mixing at a molecular level.

(Polyvinylidene Fluoride Type Resin)

In the present disclosure according to the second embodiment, examples of the polyvinylidene fluoride type resin contained in the heat-resistant adhesive porous layer include homopolymers of vinylidene fluoride (i.e. polyvinylidene fluoride); copolymers of vinylidene fluoride and other copolymerizable monomer (polyvinylidene fluoride copolymers); and mixtures thereof. Examples of the monomer polymerizable with vinylidene fluoride include tetrafluoroethylene, hexafluoropropylene, trifluoroethylene, chlorotrifluoroethylene, vinyl fluoride, and trichloroethylene, and one or two thereof can be used. Among them, a VDF-HFP copolymer is preferable from the viewpoint of adhesiveness to an electrode. As used herein, the “VDF” means a vinylidene fluoride monomer component, the “HFP” means a hexafluoropropylene monomer component, and the “VDF-HFP copolymer” means a polyvinylidene fluoride type resin having a VDF monomer component and a HFP monomer component. By copolymerizing hexafluoropropylene with vinylidene fluoride, crystallinity, heat resistance, resistance to dissolution in an electrolytic solution and the like of the polyvinylidene fluoride type resin can be each controlled to fall within an appropriate range.

For the following reasons, it is preferable that in the separator of the present disclosure according to the second embodiment, the heat-resistant adhesive porous layer contains a specific VDF-HFP copolymer that has a HFP monomer component content of from 3% by mass to 20% by mass with respect to a total amount of the total monomer components, and that has a weight average molecular weight (Mw) of from 100,000 to 1,500,000. In addition, the VDF-HFP copolymer is also preferable because it has high affinity with the acrylic type resin.

When the HFP monomer component content of the VDF-HFP copolymer is 3% by mass or more, the mobility of a polymer chain when dry heat press is performed is high, and the polymer chain enters irregularities of an electrode surface to exhibit an anchor effect, so that adhesiveness of the heat-resistant adhesive porous layer to the electrode can be improved. Further, swelling performance to an electrolyte solution is also high, so that it is easily adhered to the binder contained in the electrode by wet heat press. From this viewpoint, the HFP monomer component content of the VDF-HFP copolymer is preferably 3% by mass or more, more preferably 5% by mass or more, still more preferably 6% by mass or more.

When the HFP monomer component content of the VDF-HFP copolymer is 20% by mass or less, the copolymer is hardly dissolved and is not excessively swollen in an electrolytic solution, and therefore adhesiveness of the electrode and the heat-resistant adhesive porous layer can be maintained in the battery. From this viewpoint, the HFP monomer component content of the VDF-HFP copolymer is preferably 20% by mass or less, more preferably 18% by mass or less, still more preferably 15% by mass or less.

When the weight average molecular weight (Mw) of the VDF-HFP copolymer is 100,000 or more, the heat-resistant adhesive porous layer can secure such dynamic characteristics that the heat-resistant adhesive porous layer can endure a adhering treatment to the electrode, leading to improvement of adhesiveness to the electrode. In addition, when the weight average molecular weight (Mw) of the VDF-HFP copolymer is 100,000 or more, the copolymer is hardly dissolved in the electrolytic solution, and therefore adhesiveness of the electrode and the heat-resistant adhesive porous layer is easily maintained in the battery. From these viewpoints, the weight average molecular weight (Mw) of the VDF-HFP copolymer is preferably 100,000 or more, more preferably 200,000 or more, still more preferably 300,000 or more, still more preferably 500,000 or more.

When the weight average molecular weight (Mw) of the VDF-HFP copolymer is 1,500,000 or less, the viscosity of a coating liquid used for coating molding of the heat-resistant adhesive porous layer is not excessively high, favorable moldability and crystal formation are secured, and uniformity of surface properties of the heat-resistant adhesive porous layer is high, resulting in favorable adhesiveness of the heat-resistant adhesive porous layer to the electrode. In addition, when the weight average molecular weight (Mw) of the VDF-HFP copolymer is 1,500,000 or less, the mobility of a polymer chain when dry heat press is performed is high, and the polymer chain enters irregularities of an electrode surface to exhibit an anchor effect, so that adhesiveness of the heat-resistant adhesive porous layer to the electrode can be improved. From these viewpoints, the weight average molecular weight (Mw) of the VDF-HFP copolymer is preferably 1,500,000 or less, more preferably 1,200,000 or less, still more preferably 1,000,000 or less.

Examples of the method of producing a PVDF or a VDF-HFP copolymer include emulsion polymerization and suspension polymerization. In addition, it is also possible to select a commercially available VDF-HFP copolymer that satisfies the HFP unit content and the weight average molecular weight.

In the present disclosure, in the case that the heat-resistant resin contained in the heat-resistant adhesive porous layer is a para-wholly aromatic polyamide, when the polyvinylidene fluoride type resin is further added in addition to the para-wholly aromatic polyamide and the acrylic type resin which are the constituent components of the heat-resistant adhesive porous layer, dry adhesive strength tends to be further increased. Though the reason is not clear, it is considered that the acrylic type resin and the polyvinylidene fluoride type resin are partially compatibilized, thereby lowering the glass transition temperature of the acrylic type resin, so that the acrylic type resin having a high adhesive function is wet by the press to be easily spread. Meanwhile, the adhesion to an electrode is also possible in the wet heat press in the electrolyte solution (wet adhesion). Though the reason is also not clear, it is considered that the acrylic type resin and the polyvinylidene fluoride type resin are partially swelled in the electrolyte solution, causing electrical interaction with the binder of the electrode, or entanglement of the polymer chains by the press, thereby obtaining high adhesive strength.

(Other Resins)

In the present disclosure, the heat-resistant adhesive porous layer may contain other resins in addition to the heat-resistant resin, the acrylic type resin and the vinylidene fluoride type resin.

Examples of other resins include fluorine-based rubber, styrene-butadiene copolymers, homopolymers or copolymers of vinylnitrile compounds (acrylonitrile, methacrylonitrile and the like), carboxymethyl cellulose, hydroxyalkyl cellulose, polyvinyl alcohol, polyvinyl butyral, polyvinyl pyrrolidone, and polyethers (polyethylene oxide, polypropylene oxide and the like).

(Filler)

In the present disclosure, the heat-resistant adhesive porous layer may contain a filler composed of an inorganic substance or an organic substance for the purpose of improving the sliding properties and heat resistance of the separator. In that case, it is preferable to set a content and a particle size so as not to hinder the effect of the present disclosure. From the viewpoint of improving cell strength and securing the safety of the battery, the filler is preferably an inorganic filler.

The average particle size of the filler is preferably from 0.01 μm to 5 μm. The lower limit thereof is more preferably 0.1 μm or more, and the upper limit thereof is more preferably 1 μm or less.

The inorganic filler is preferably one that is stable to an electrolytic solution and that is electrochemically stable. Specific examples of the inorganic filler include metal hydroxides such as aluminum hydroxide, magnesium hydroxide, calcium hydroxide, chromium hydroxide, zirconium hydroxide, cerium hydroxide, nickel hydroxide and boron hydroxide; metal oxides such as alumina, titania, magnesia, silica, zirconia and barium titanate; carbonates such as calcium carbonate and magnesium carbonate; sulfates such as barium sulfate and calcium sulfate; and clay minerals such as calcium silicate and talc. The inorganic filler may be used singly, or in combination of two or more kinds thereof. The inorganic filler may be one which is surface-modified with a silane coupling agent.

The inorganic filler is preferably at least one of a metal hydroxide or a metal oxide from the viewpoint of securing stability in the battery and the safety of the battery, and from the viewpoint of impartment of flame retardancy and the electricity eliminating effect, a metal hydroxide is preferable, and magnesium hydroxide is more preferable.

The particle configuration of the inorganic filler is not limited, and may be a shape close to a sphere or a plate shape, but from the viewpoint of suppressing a short-circuit of the battery, plate-shaped particles and primary particles that are not aggregated are preferable.

When the heat-resistant adhesive porous layer contains an inorganic filler, the content of the inorganic filler in the heat-resistant adhesive porous layer is preferably from 5% by mass to 80% by mass with respect to a total amount of the total resins and the inorganic filler contained in the heat-resistant adhesive porous layer. The content of the inorganic filler is preferably 5% by mass or more from the viewpoint of dimensional stability because thermal shrinkage of the separator is suppressed in application of heat. From this viewpoint, the content of the inorganic filler is more preferably 10% by mass or more, still more preferably 20% by mass or more. The content of the inorganic filler is preferably 80% by mass or less because adhesiveness of the heat-resistant adhesive porous layer to the electrode is secured. From this viewpoint, the content of the inorganic filler is more preferably 75% by mass or less, still more preferably 70% by mass or less.

Examples of the organic filler include crosslinked acrylic type resins such as crosslinked polymethyl methacrylate, crosslinked polystyrene, and crosslinked urethane resins, and crosslinked polymethyl methacrylate is preferable.

(Other Components)

In the present disclosure, the heat-resistant adhesive porous layer may contain additives such as a dispersant such as a surfactant, a wetting agent, a defoaming agent, and a pH adjusting agent. For the purpose of improving dispersibility, coatability and storage stability, the dispersant is added to a coating liquid to be used for the coating molding of the heat-resistant adhesive porous layer. For the purpose of, for example, improving compatibility with the porous substrate, inhibiting air from being caught in the coating liquid, or adjusting pH, the wetting agent, the defoaming agent and the pH adjusting agent are added to the coating liquid to be used for coating molding of the heat-resistant adhesive porous layer.

[Characteristics of Heat-Resistant Adhesive Porous Layer]

In the present disclosure, the thickness of the heat-resistant adhesive porous layer at one side of the porous substrate is preferably 0.5 μm or more, more preferably 1.0 μm or more from the viewpoint of adhesiveness to the electrode, and is preferably 8.0 μm or less, more preferably 6.0 μm or less from the viewpoint of the energy density of the battery.

When the heat-resistant adhesive porous layers are provided on both sides of the porous substrate, a difference between the thickness of the heat-resistant adhesive porous layer at one side and the thickness of the heat-resistant adhesive porous layer at the other side is preferably 20% or less with respect to a total thickness at both sides, and the difference is preferably as low as possible.

The weight of the heat-resistant adhesive porous layer at one side of the porous substrate is preferably 0.5 g/m² or more, more preferably 0.75 g/m² or more from the viewpoint of adhesiveness to the electrode, and is preferably 5.0 g/m² or less, more preferably 4.0 g/m² or less from the viewpoint of ion permeability.

The porosity of the heat-resistant adhesive porous layer is preferably 30% or more from the viewpoint of ion permeability, and is preferably 80% or less, more preferably 60% or less from the viewpoint of dynamic strength. The method of determining the porosity of the heat-resistant adhesive porous layer in the present disclosure is the same as the method of determining the porosity of the porous substrate.

The average pore size of the heat-resistant adhesive porous layer is preferably 10 nm or more from the viewpoint of ion permeability, and is preferably 200 nm or less from the viewpoint of adhesiveness to the electrode. The average pore size of the heat-resistant adhesive porous layer in the present disclosure is calculated from the following formula with respect to the assumption that all the pores are cylindrical.

d=4V/S

In the formula, d represents an average pore size (diameter) of the heat-resistant adhesive porous layer, V represents a pore volume per 1 m² of the heat-resistant adhesive porous layer, and S represents a pore surface area per 1 m² of the heat-resistant adhesive porous layer.

The pore volume V per 1 m² of the heat-resistant adhesive porous layer is calculated from the porosity of the heat-resistant adhesive porous layer. The pore surface area S per 1 m² of the heat-resistant adhesive porous layer is determined by the following method.

First, a specific surface area (m²/g) of the porous substrate and a specific surface area (m²/g) of the separator are calculated from a nitrogen gas adsorption amount by applying the BET equation to a nitrogen gas adsorption method. The specific surface areas (m²/g) are multiplied by respective basis weights (g/m²) to calculate respective pore surface areas per 1 m². The pore surface area per 1 m² of the porous substrate is subtracted from the pore surface area per 1 m² of the separator to calculate the pore surface area S per 1 m² of the heat-resistant adhesive porous layer.

The peeling strength between the porous substrate and the heat-resistant adhesive porous layer is preferably 0.10 N/10 mm or more. When the peeling strength is 0.10 N/10 mm or more, the separator has excellent handling characteristics in a process for production of a battery. From this viewpoint, the peeling strength is more preferably 0.20 N/10 mm or more, and is preferably as high as possible. The upper limit of the peel strength is not limited, but is generally 2.0 N/10 mm or less.

[Other Layer]

On one side or both sides of the composite membrane including the above-described porous substrate and the heat-resistant adhesive porous layer, an adhesive porous layer containing a polyvinylidene fluoride type resin may be further provided. In this case, an effect of further improving adhesion to an electrode by the adhesive porous layer is expected.

Here, in the case of forming the adhesive porous layer containing the polyvinylidene fluoride type resin on the heat-resistant layer containing the heat-resistant resin such as the wholly aromatic polyamide, the affinity between the wholly aromatic polyamide and the polyvinylidene fluoride type resin is poor, so that the adhesive porous layer is easily peeled off to deteriorate the handling characteristics. In this regard, in the separator of the present disclosure, the acrylic type resin, or the mixture of the acrylic type resin and the polyvinylidene fluoride type resin in the heat-resistant adhesive porous layer is closely well adhered to the adhesive porous layer containing the polyvinylidene fluoride type resin, thereby improving the handling characteristics, and also having excellent heat resistance and adhesion.

Examples of the polyvinylidene fluoride type resin include homopolymers of vinylidene fluoride (i.e. polyvinylidene fluoride); copolymers of vinylidene fluoride and other copolymerizable monomer (polyvinylidene fluoride copolymers); and mixtures thereof. Examples of the monomer polymerizable with vinylidene fluoride include tetrafluoroethylene, hexafluoropropylene, trifluoroethylene, chlorotrifluoroethylene, vinyl fluoride, and trichloroethylene, and one or two thereof can be used. Among them, a VDF-HFP copolymer is preferable from the viewpoint of adhesiveness to an electrode. As used herein, the “VDF” means a vinylidene fluoride monomer component, the “HFP” means a hexafluoropropylene monomer component, and the “VDF-HFP copolymer” means a polyvinylidene fluoride type resin having a VDF monomer component and a HFP monomer component.

In addition, it is preferred that the adhesive porous layer containing the polyvinylidene fluoride type resin further contains a filler. By having this form, it is possible to further increase the stability of the separator (heat resistance, nail penetration test resistance, etc.). As the filler, the filler as described for the heat-resistant adhesive porous layer may be used.

[Characteristics of Separator]

The thickness of the separator of the present disclosure is preferably 5 μm or more from the viewpoint of mechanical strength, and is preferably 35 μm or less from the viewpoint of energy density of the battery.

The puncture strength of the separator of the present disclosure is preferably from 250 g to 1,000 g, more preferably from 300 g to 600 g. The method of measuring the puncture strength of the separator is the same as the method of measuring the puncture strength of the porous substrate.

The porosity of the separator of the present disclosure is preferably from 30% to 65%, more preferably from 30% to 60% from the viewpoints of adhesiveness to the electrode, handling characteristics, ion permeability, and mechanical strength.

The Gurley value (JIS P 8117: 2009) of the separator of the present disclosure is preferably from 100 sec/100 cc to 300 sec/100 cc from the viewpoint of mechanical strength and the load characteristics of the battery.

[Method for Producing a Separator]

### (Method for Producing a Separator of Type A)

A separator of above-described type A may be produced by a wet-type coating method containing the following steps (i) to (iii):

(i) applying a coating liquid onto the porous substrate to form a coated layer, wherein the coating liquid contains a heat-resistant resin that has a glass transition temperature of 200° C. or more and that has an amide-structure, an acrylic type resin, and a solvent that dissolves the heat-resistant resin and the acrylic type resin, or applying a coating liquid onto the porous substrate to form a coated layer, wherein the coating liquid contains the aforementioned heat-resistant resin, an acrylic type resin, a polyvinylidene fluoride type resin and a solvent that dissolves the aforementioned heat-resistant resin, the acrylic type resin and the polyvinylidene fluoride type resin;

(ii) immersing the porous substrate having the coated layer formed thereon in a coagulation liquid, wherein the coagulation liquid contains a poor solvent for the heat-resistant resin and the acrylic type resin, to solidify the heat-resistant resin and the acrylic type resin, while inducing a phase separation in the coated layer, or immersing the porous substrate having the coated layer formed thereon in a coagulation liquid, wherein the coagulation liquid contains a poor solvent for the heat-resistant resin, the acrylic type resin and the polyvinylidene fluoride type resin, to solidify the heat-resistant resin, the acrylic type resin and the polyvinylidene fluoride type resin, while inducing a phase separation in the coated layer, to form a porous layer on the porous substrate, thereby obtaining a composite membrane; and

(iii) washing with water and drying the composite membrane.

The coating liquid is prepared by dissolving or dispersing an acrylic type resin and a heat-resistant resin that has a glass transition temperature of 200° C. or more and that has an amide-structure, or by dissolving or dispersing the aforementioned heat-resistant resin, an acrylic type resin and a polyvinylidene fluoride type resin, in a solvent. In a case in which a filler is contained in the heat-resistant adhesive porous layer, the filler is dispersed in the coating liquid.

The solvent to be used in preparation of the coating liquid includes a solvent (hereinafter, referred to as a “good solvent”) that dissolves a heat-resistant resin and an acrylic type resin, or dissolves a heat-resistant resin, acrylic type resin and a polyvinylidene fluoride type resin. Examples of the good solvent include polar amide solvents such as N-methylpyrrolidone, dimethylacetamide and dimethylformamide.

In the case that the heat-resistant resin is a para-wholly aromatic polyamide, the coating liquid may contain an inorganic salt such as calcium chloride, for the purpose of assisting solubility of the para-wholly aromatic polyamide.

Preferably, the solvent to be used for preparation of the coating liquid contains a phase separation agent that induces phase separation from the viewpoint of forming a porous layer having a favorable porous structure. Thus, the solvent to be used for preparation of the coating liquid is preferably a mixed solvent of a good solvent and a phase separation agent. Preferably, the phase separation agent is mixed with a good solvent in an amount in a range which ensures that a viscosity suitable for coating can be secured. Examples of the phase separation agent include water, methanol, ethanol, propyl alcohol, butyl alcohol, butanediol, ethylene glycol, propylene glycol and tripropylene glycol.

The solvent to be used for preparation of the coating liquid is preferably a mixed solvent of a good solvent and a phase separation agent, which contains the good solvent in an amount of 60% by mass or more and the phase separation agent in an amount of 40% by mass or less, from the viewpoint of forming a favorable porous structure.

According to the first embodiment of the present disclosure, the concentration of the resin in the coating liquid is preferably from 1% by mass to 20% by mass, in terms of forming a good porous structure. In particular, the heat-resistant resin having an amide-structure and the acrylic type resin may have a so-called, lower critical solution temperature (LCST) type phase diagram in some cases in which the resins are separated into two phases at high temperature, and becomes one compatibilized phase at low temperature near room temperature, in a mixed solvent of a good solvent and a phase separating agent. When producing the separator of the present invention, it is preferred to use a one-phase coating liquid, or a two-phase coating liquid which is partially compatibilized in a translucent state. The heat-resistant resin and the acrylic type resin are coated on the porous substrate in a compatibilized or partially compatibilized state as such, and solidified and phase-separated, thereby capable of forming a structure in which the acrylic type resin that has a particle configuration with a size of from 10 nm to 500 nm is dispersed in the three-dimensional network structure of the heat-resistant resin. From this point of view, the resin concentration of the coating liquid is preferably from 2% by mass to 13% by mass, and more preferably in a range of from 3% by mass to 10% by mass.

In addition, the coating liquid used in the second embodiment of the present invention contains the polyvinylidene fluoride type resin in addition to the heat-resistant resin and the acrylic type resin. By adding the polyvinylidene fluoride type resin, it is possible to obtain stronger dry adhesion and wet adhesion.

According to the second embodiment of the present disclosure, the resin concentration of the coating liquid is preferably from 1% by mass to 15% by mass, in terms of forming a good porous structure. In particular, for the heat-resistant resin having an amide-structure, the acrylic type resin, and the polyvinylidene fluoride type resin, it is preferred to use a one-phase coating liquid, or a two-phase coating liquid which is partially compatibilized in a translucent state, in the mixed solvent of the good solvent and the phase separating agent. The heat-resistant resin, acrylic type resin, and polyvinylidene fluoride type resin are coated on the porous substrate in a compatibilized or partially compatibilized state as such, and solidified and phase-separated, thereby capable of forming a structure in which a mixture that has a particle configuration with a size of from 10 nm to 500 nm and that is composed of the acrylic type resin and the polyvinylidene fluoride type resin is dispersed in the three-dimensional network structure of the heat-resistant resin. From this point of view, the resin concentration of the coating liquid is preferably from 2% by mass to 13% by mass, and more preferably from 3% by mass to 10% by mass. In order to obtain the one-phase coating liquid, or the two-phase coating liquid which is partially compatibilized in a translucent state, in the mixed solvent of the good solvent and the phase separating agent, having the resin concentration of the coating liquid in a range of from 1% by mass to 15% by mass, it is preferred that from 30% by mass to 80% by mass of the heat-resistant resin, from 10% by mass to 40% by mass of the acrylic type resin, and from 10% by mass to 30% by mass of the polyvinylidene fluoride type resin are contained, with respect to a total mass of the heat-resistant resin, the acrylic type resin and the polyvinylidene fluoride type resin, and at the same time, from 5% by mass to 55% by mass of the polyvinylidene fluoride type resin is contained, with respect to a total mass of the acrylic type resin and the polyvinylidene fluoride type resin. In general, the affinity between the heat-resistant resin having an amide-structure and the polyvinylidene fluoride type resin is low, so that it is difficult to mix them uniformly at a molecular level. However, it is considered that since the acrylic type resin having high affinity with both of the resins serves as a compatibilizer of both of the resins to homogeneously mix the resins at a molecular level, a transparent or translucent coating liquid (coating composition for a non-aqueous secondary battery) can be prepared.

Examples of means for coating the porous substrate with a coating liquid include a Meyer bar, a die coater, a reverse roll coater and a gravure coater. In a case in which the porous layer is formed on both surfaces of the porous substrate, it is preferable to simultaneously coat the both surfaces with the coating liquid from the viewpoint of productivity.

The coagulation liquid may contain only water, but generally contains water, and the good solvent and phase separation agent used for preparation of the coating liquid. From the viewpoint of production, it is preferable that the mixing ratio of the good solvent and the phase separation agent is made consistent with the mixing ratio of the mixed solvent used for preparation of the coating liquid. The content of water in the coagulation liquid is preferably from 40% by mass to 90% by mass from the viewpoint of productivity and formation of a porous structure. The temperature of the coagulation liquid is, for example, from 20° C. to 50° C.

The separator of the present invention is produced by washing the separator after being solidified with water, and drying the separator. The heat-resistant adhesive porous layer of the separator obtained after water washing has a structure in which the acrylic type resin that has a particle configuration with a size of from 10 nm to 500 nm, or the mixture that has a particle configuration with a size of from 10 nm to 500 nm and that is composed of the acrylic type resin and the polyvinylidene fluoride type resin, is dispersed in the three-dimensional network structure of the heat-resistant resin. In the case that the glass transition temperature of the acrylic type resin is from 0° C. to 80° C., the separator is in a state of almost maintaining the structure after wash, even after drying. The drying temperature is preferably from 55° C. to 105° C. In particular, when the heat-resistant resin is a para-wholly aromatic polyamide, the drying temperature is preferably from 65° C. to 105° C.

(Method for Producing a Separator of Type B)

The above-described separator of type B can be produced by using the acrylic type resin having the glass transition temperature less than 0° C. as the acrylic type resin in the method of producing the separator of type A. Since the acrylic type resin having the glass transition temperature less than 0° C. often contains a long chain alkyl group and the like in the molecular skeleton, the acrylic type resin itself tends to have lower surface tension, and in some cases, has surface tension lower than the heat-resistant resin having an amide skeleton. Thus, when the acrylic type resin is treated at high temperature in the drying step, it causes spontaneous wetting itself, thereby becoming the heat-resistant adhesive porous layer having a structure in which the surface of the three-dimensional network structure of the heat-resistant resin is coated.

Further, a separator of type B may be produced by another method, such as a wet-type method containing the following steps (i) to (iii). In this regard, the overlapping explanation with the conditions for producing a separator of type A is abbreviated.

(i) Applying a coating liquid onto the porous substrate to form a coated layer, wherein the coating liquid contains a heat-resistant resin that has a glass transition temperature of 200° C. or more and that has an amide-structure, an acrylic type resin that is an aqueous emulsion and a solvent that dissolves the heat-resistant resin, or applying a coating liquid onto the porous substrate to form a coated layer, wherein the coating liquid contains the aforementioned heat-resistant resin, an acrylic type resin that is an aqueous emulsion, a polyvinylidene fluoride type resin and a solvent that dissolves the heat-resistant resin and the polyvinylidene fluoride type resin;

(ii) immersing the porous substrate having the coated layer formed thereon in a coagulation liquid, wherein the coagulation liquid contains a poor solvent for the heat-resistant resin, to solidify the heat-resistant resin, while inducing a phase separation in the coated layer, or immersing the porous substrate having the coated layer formed thereon in a coagulation liquid, wherein the coagulation liquid contains a poor solvent for the heat-resistant resin and the polyvinylidene fluoride type resin, to solidify the heat-resistant resin and the polyvinylidene fluoride type resin, while inducing a phase separation in the coated layer, to form a porous layer on the porous substrate, thereby obtaining a composite membrane; and

(iii) washing with water and drying the composite membrane.

In the above step (i), as the solvent which can dissolve the heat-resistant resin, or the solvent which can dissolve the heat-resistant resin and the polyvinylidene fluoride type resin, the solvent in the above-described method of producing type A may be used, respectively.

Since water is a poor solvent of the coating liquid, a predetermined amount of the acrylic type resin cannot be added unless the solid content concentration of the aqueous emulsion is increased. Thus, solid content concentration of the aqueous emulsion in the coating liquid is preferably from 30% by mass to 80% by mass. When the solid content concentration is 80% by mass or less, aggregation of emulsion particles can be suppressed, and it is possible to disperse the acrylic type resin having a particle configuration in the three-dimensional network structure of the heat-resistant resin. Meanwhile, when the solid content concentration is 30% by mass or more, it is possible to add acrylic type resin particles in an amount capable of exhibiting adhesive performance.

As the acrylic type resin as the aqueous emulsion, the acrylic type resin having a glass transition temperature less than 0° C. is preferred.

It is preferred that an average particle size of the emulsion particles is in a range of from 10 nm to 500 nm. When the particle size is 500 nm or less, gas or liquid can pass from one surface to the other surface. Meanwhile, the emulsion particle size is more than 10 nm, sufficient adhesion to an electrode can be obtained. The preferred range of the emulsion particle size is from 20 nm to 200 nm, and more preferably from 25 nm to 100 nm.

Since the aqueous emulsion is added to a good solvent in the present production method, the coating liquid tends to have higher surface tension. Thus, the wettability of the coating liquid to the porous substrate is reduced, and the coated film may be peeled off from the porous substrate in the solidification or water washing step. In this case, it is preferred to add a water-soluble surfactant to the coating liquid. The water-soluble surfactant can be extracted in the water washing step. The water-soluble surfactant is not particularly limited, however, a fluorine-based surfactant is more preferred, since it decreases the surface tension of the organic solvent.

(Other Production Methods)

The separator of the present disclosure can also be produced by a dry-type coating method. The dry-type coating method is a method in which a porous substrate is coated with a coating liquid containing a resin to form a coated layer, and the coated layer is then dried to solidify the coated layer, whereby a porous layer is formed on the porous substrate. However, in the dry-type coating method, the porous layer is more easily densified as compared to the wet-type coating method, and therefore the wet-type coating method is preferable from the viewpoint of obtaining a favorable porous structure.

The separator of the present disclosure can also be produced by a method in which a porous layer is prepared as an independent sheet, and the porous layer is superimposed on a porous substrate, and laminated thereto by thermocompression adhering or with an adhesive. Examples of the method of preparing a porous layer as an independent sheet include a method in which a porous layer is formed on a release sheet using the wet-type coating method or dry-type coating method, and the release sheet is separated from the porous layer.

<Non-Aqueous Secondary Battery>

A non-aqueous secondary battery of the present disclosure is a non-aqueous secondary battery which produces an electromotive force by lithium doping and dedoping, the non-aqueous secondary battery including a positive electrode, a negative electrode, and the separator for a non-aqueous secondary battery of the present disclosure. The doping means absorption, holding, adsorption or insertion, which means a phenomenon in which lithium ions enter an active material of an electrode such as a positive electrode.

The non-aqueous secondary battery of the present disclosure has, for example, a structure in which a battery element with a negative electrode and a positive electrode facing each other with a separator interposed therebetween is enclosed in an outer packaging material together with an electrolytic solution. The non-aqueous secondary battery of the present disclosure is suitable as a non-aqueous electrolyte secondary battery, particularly a lithium ion secondary battery.

Since the separator of the present disclosure is well adhered to the electrode by the dry heat press, the non-aqueous secondary battery of the present disclosure has a high production yield, and excellent cycle characteristics (capacity retention ratio) of the battery. In addition, since the heat-resistant adhesive porous layer has high heat resistance, even when the temperature of the battery is high, thermal shrinkage of the porous substrate is suppressed, and a battery having improved stability is obtained. In particular, according to the second embodiment of the present disclosure, since the heat-resistant adhesive porous layer has high heat resistance, and is well adhered to the electrode by the wet heat press, the thermal shrinkage of the porous substrate is suppressed even when the temperature of the battery is high, and the battery having improved stability is obtained.

Hereinafter, examples of embodiment of a positive electrode, a negative electrode, an electrolytic solution and an outer packaging material each included in the non-aqueous secondary battery of the present disclosure will be described.

Examples of the embodiment of the positive electrode include a structure in which an active material layer containing a positive electrode active material and a binder resin is disposed on a current collector. The active material layer may further contain a conductive auxiliary agent. Examples of the positive electrode active material include lithium-containing transition metal oxides, specific examples thereof include LiCoO₂, LiNiO₂, LiMn_{1/2}Ni_{1/2}O₂, LiCo_{1/3}Mn_{1/3}Ni_{1/3}O₂, LiMn₂O₄, LiFePO₄, LiCo_{1/2}Ni_{1/2}O₂ and LiAl_{1/4}Ni_{3/4}O₂. Examples of the binder resin include polyvinylidene fluoride type resins, and styrene-butadiene copolymers. Examples of the conductive auxiliary agent include carbon materials such as acetylene black, ketjen black and graphite powders. Examples of the current collector include aluminum foils, titanium foils and stainless foils having a thickness of, for example, from 5 μm to 20 μm.

In the non-aqueous secondary battery of the present disclosure, the heat-resistant resin having an amide-structure contained in the heat-resistant adhesive porous layer of the separator of the present disclosure is excellent in oxidation resistance, and therefore by disposing the heat-resistant adhesive porous layer on the positive electrode side in the non-aqueous secondary battery, LiMn_{1/2}Ni_{1/2}O₂, LiCo_{1/3}Mn_{1/3}Ni_{1/3}O₂ or the like, which is capable of operating at a high voltage of 4.2V or more, is easily applied as the positive electrode active material.

Examples of the embodiment of the negative electrode include a structure in which an active material layer containing a negative electrode active material and a binder resin is disposed on a current collector. The active material layer may further contain a conductive auxiliary agent. Examples of the negative electrode active material include materials capable of electrochemically absorbing lithium, specific examples thereof include carbon materials; alloys of lithium with silicon, tin, aluminum or the like; and wood alloys. Examples of the binder resin include polyvinylidene fluoride type resins, and styrene-butadiene copolymers. Examples of the conductive auxiliary agent include carbon materials such as acetylene black, ketjen black, graphite powders and ultra-thin carbon fibers. Examples of the current collector include copper foils, nickel foils and stainless foils having a thickness of, for example, from 5 μm to 20 μm. In place of the negative electrode described above, a metal lithium foil may be used as a negative electrode.

The electrolytic solution is a solution obtained by dissolving a lithium salt in a non-aqueous solvent. Examples of the lithium salt include LiPF₆, LiBF₄ and LiClO₄. Examples of the non-aqueous solvent include cyclic carbonates such as ethylene carbonate, propylene carbonate, fluoroethylene carbonate, difluoroethylene carbonate and vinylene carbonate; chain carbonates such as dimethyl carbonate, diethyl carbonate, ethylmethyl carbonate and fluorine-substituted products thereof; and cyclic esters such as γ-butyrolactone and γ-valerolactone. They may be used singly, or in combination of two or more kinds thereof. The electrolytic solution is preferably a solution obtained by mixing cyclic carbonate and chain carbonate at a mass ratio (cyclic carbonate:chain carbonate) of from 20:80 to 40:60, and dissolving a lithium salt therein in an amount of from 0.5 mol/L to 1.5 mol/L.

Examples of the outer packaging material include metal cans and aluminum laminated film packages. Examples of the shape of the battery include a rectangular shape, a circular-cylindrical shape and a coin shape, and the separator of the present disclosure is suitable for any shape.

Examples of the method of producing the non-aqueous secondary battery of the present disclosure include a method in which a separator is adhered to an electrode by performing a heat press treatment (referred to as “dry heat press” in the present disclosure) without impregnating the separator with an electrolytic solution, and the separator is then impregnated with the electrolytic solution. The production method includes, for example, a lamination step of producing a laminated body in which the separator of the present disclosure is disposed between a positive electrode and a negative electrode; a dry adhering step of adhering the electrodes and the separator to each other by subjecting the laminated body to dry heat press; and a post step of injecting an electrolytic solution into the laminated body stored in an outer packaging material, and sealing the outer packaging material.

An example of the method of producing the non-aqueous secondary battery of the present disclosure may include a method of injecting an electrolyte solution into a laminated body stored in an outer packaging material, sealing the outer packaging material, and then performing heat press treatment (also referred to as “wet heat press” in the present disclosure), and a method of combining the dry heat press and the wet heat press.

The manner of disposing a separator between a positive electrode and a negative electrode in the lamination step may be a manner in which at least one positive electrode, separator and negative electrode are layered in this order one on another (so called a stacking method), or a manner in which a positive electrode, a separator, a negative electrode and a separator are superimposed one on another in this order, and wound in the length direction.

The dry adhering step may be carried out before the laminated body is stored in the outer packaging material (e.g. a pack made of an aluminum laminate film), or after the laminated body is stored in the outer packaging material. That is, the laminated body in which the electrodes and the separators are adhered to each other by dry heat press may be stored in the outer packaging material, or the electrodes and the separators may be adhered to each other by performing dry heat press from outside of the outer packaging material after storage of the laminated body in the outer packaging material.

The pressing temperature in the dry adhering step is preferably from 70° C. to 120° C., more preferably from 75° C. to 110° C., still more preferably from 80° C. to 100° C. When the pressing temperature is in the above-mentioned range, the electrode and the separator are favorably adhered to each other, and the separator can be moderately expanded in a width direction, so that a short-circuit of the battery hardly occurs.

The press pressure in the dry adhering step is preferably from 0.5 kg to 40 kg in terms of a load per 1 cm² of the electrode. Preferably, the pressing time is adjusted according to the pressing temperature and the press pressure. For example, the pressing time is adjusted to fall within a range of 0.1 minutes to 60 minutes.

In the above-mentioned production method, the laminated body may be temporarily adhered by subjecting the laminated body to press at room temperature (pressurization at normal temperature) before dry heat press is performed.

In the subsequent step, after performing the dry heat press, the electrolyte solution is injected into the outer packaging material storing the laminated body, and the outer packaging material is sealed. After injection of the electrolyte solution, the laminated body may be further hot-pressed onto the outer packaging material.

The wet adhering step may be carried out after the laminated body is stored in the outer packaging material to inject the electrolyte solution, and then the outer packaging material is sealed. The wet adhering step may be carried out on the outer packaging material which has already completed dry adhesion, or the outer packaging material which has not been subjected to dry adhesion. The press temperature in the wet adhering step is preferably from 50° C. to 100° C., more preferably from 60° C. to 90° C., still more preferably from 65° C. to 85° C. Within this temperature range, the decomposition of the electrolyte solution can be suppressed, the adhesion between the electrode and the separator is good, and also the separator can be appropriately expanded in a width direction, so that a short-circuit of the battery hardly occurs.

The press pressure in the wet adhering step is preferably from 0.5 kg to 20 kg in terms of a load per 1 cm² of the electrode. Preferably, the pressing time is adjusted according to the pressing temperature and the press pressure, for example, is adjusted to fall within a range of from 0.1 minutes to 60 minutes.

Besides, before sealing, it is preferred that the inside of the outer packaging material is brought into vacuum state. As a method of sealing the outer packaging material, for example, a method of bonding the opening portion of the outer packaging material with an adhesive, and a method of hot-pressing the opening portion of the outer packaging material by heat pressurization.

<Coating Composition for Non-Aqueous Secondary Battery>

In addition, in the second embodiment, the separator for the non-aqueous secondary battery including the porous substrate and the heat-resistant adhesive porous layer was described, but the present invention is not limited thereto. That is, the present invention can be also grasped as a coating composition for a non-aqueous secondary battery including the acrylic type resin, the polyvinylidene fluoride type resin, and the heat-resistant resin that has a glass transition temperature of 200° C. or more and that has an amide-structure. This coating composition can form a composite membrane separator, when coated on the porous substrate, as described above, and for example, when coated on a positive electrode active material layer, or a negative electrode active material layer, the separator can solve the problem of the present invention, even in the case of using the conventional polyethylene microporous membrane. In addition, a method in which the coating composition is coated on a release sheet to form a porous membrane, which is peeled off to form a separate sheet, and the separate sheets are superimposed on the separator composed of a conventional polyethylene microporous membrane, and then superimposed on the electrode again, can be considered.

In addition, since conventionally, the affinity between the polyvinylidene fluoride type resin and the heat-resistant resin that has a glass transition temperature of 200° C. or more and that has an amide-structure is poor, a uniform and transparent coating liquid cannot be prepared even by dissolving them in a solvent. Thus, it is a new knowledge itself that the acrylic type resin is added as the compatibilizer of the heat-resistant resin and the polyvinylidene fluoride type resin, thereby forming a transparent solution in which these three resins are homogeneously mixed at a molecular level. Accordingly, the coating composition for a non-aqueous secondary battery including the above-described heat-resistant resin, acrylic type resin, polyvinylidene fluoride type resin, and the solvent thereof can be an object of independent commercial transactions, and have high industrial availability.

### EXAMPLES

The separator and the non-aqueous secondary battery of the present disclosure will be described further in detail below with reference to the examples. Materials, use amounts, ratios, process procedures, and the like shown in the following examples can be appropriately changed without departing from the spirit of the present disclosure. Therefore, the scope of the separator and the non-aqueous secondary battery of the present disclosure should not be construed to be limited by the following specific examples.

<Measurement Methods and Evaluation Methods>

Measurement methods and evaluation methods applied in examples and comparative examples are as follows.

[Weight Average Molecular Weight of Resin]

The weight average molecular weight (Mw) of the resin was measured as a molecular weight in terms of polystyrene under the condition of a temperature of 40° C. and a flow rate of 10 ml/min by using a gel permeation chromatography analyzer (GPC-900 from JASCO Corporation), using two columns: TSKgel SUPER AWM-H from TOSOH CORPORATION, and using N,N-dimethylformamide as a solvent.

[Glass Transition Temperature of Resin]

The glass transition temperature of the resin was determined from a differential scanning calorimetry curve (DSC curve) obtained by performing differential scanning calorimetry (DSC). The glass transition temperature is a temperature at a point where a straight line obtained by extending a base line on the low temperature side to the high temperature side crosses a tangent line of a curve at a step-like change part, which has the largest gradient.

[Thickness of Each of Porous Substrate and Separator]

The thickness (μm) of each of the porous substrate and the separator was determined by measuring the thickness at 20 spots within using a contact-type thickness meter (LITEMATIC manufactured by Mitutoyo Corporation), and averaging the measured values. As a measurement terminal, a terminal having a circular-cylindrical shape with a diameter of 5 mm was used, and an adjustment was made so that a load of 7 g was applied during the measurement.

[Layer Thickness of Heat-Resistant Adhesive Porous Layer]

For the layer thickness (μm) of the heat-resistant adhesive porous layer, a total layer thickness on both sides was determined by subtracting the thickness of the porous substrate from the thickness of the separator, and a half of the total layer thickness was defined as a layer thickness on one side.

[Gurley Value]

The Gurley value (seconds/100 cc) of each of the porous substrate and the separator was measured using a Gurley-type Densometer (G-B2C from TOYO SEIKI SESAKU-SHO) in accordance with JIS P8117: 2009.

[Porosity]

The porosity (%) of each of the porous substrate and the heat-resistant adhesive porous layer was determined in accordance with the following formula.

ε={1−Ws/(ds·t)}×100

In the formula, ε represents a porosity (%), Ws represents a basis weight (g/m²), ds represents a true density (g/cm³), and t represents a thickness (μm).

[Peeling Strength Between Porous Substrate and Heat-Resistant Adhesive Porous Layer]

An adhesive tape was attached to one surface of the separator (the longitudinal direction of the adhesive tape was made coincident with the MD direction of the separator in attachment of the tape), and the separator, together with the adhesive tape, was cut to a size of 1.2 cm in the TD direction and 7 cm in the MD direction. The adhesive tape was slightly peeled off together with the heat-resistant adhesive porous layer immediately below the tape, two separated end parts were held in Tensilon (RTC-1210A manufactured by Orientec Co., Ltd.), and a T-shape peeling test was conducted. The adhesive tape was used as a support for peeling the heat-resistant adhesive porous layer from the porous substrate. The tension speed in the T-shape peeling test was set to 20 mm/min, and a load (N) in peeling of the heat-resistant adhesive porous layer from the porous substrate was measured. A load was measured at intervals of 0.4 mm up to 40 mm from 10 mm after the start of measurement, and an average thereof was calculated, and converted into a load per width of 10 mm (N/10 mm). Further, measured values for three test pieces were averaged, and the average was defined as a peeling strength (N/10 mm). The peeling strength was considered as an index for evaluating handling performance of the separator.

[Adhesiveness to Adhesive Porous Layer]

On the separators produced in the following Examples and Comparative Examples, the adhesive porous layer containing the polyvinylidene fluoride type resin was laminated, as follows, and the adhesiveness between the adhesive porous layer and the heat-resistant adhesive porous layer was confirmed.

A VDF-HFP binary copolymer (an HFP unit ratio of 5.1% by mass, a weight average molecular weight of 1,130,000) which is the polyvinylidene fluoride type resin was dissolved in a mixed solvent of dimethylacetamide and tripropylene glycol (dimethylacetamide:tripropylene glycol=80:20 [mass ratio]) so that a resin concentration was 5% by mass. To this solution, further, carbon powder having an average diameter of 1 μm as the inorganic filler was added, and stirred until the solution became uniform to prepare a coating liquid. In the coating liquid, the compositional ratio of the PVDF type resin and the inorganic filler was 60:40 (mass ratio). This coating liquid was coated in an equal amount on both sides of each separator produced in the Examples and the Comparative Examples, and the separator was immersed in a coagulation liquid (water:dimethylacetamide:tripropylene glycol=62:30:8 [mass ratio], a temperature of 40° C.) to be solidified. Next, this separator was washed with water and dried, thereby obtaining the separator having an adhesive porous layer formed on both sides of the heat-resistant adhesive porous layer.

On one side of the obtained separator, an adhesive tape was attached, and the adhesive tape was detached from the separator, thereby evaluating the adhesiveness between the adhesive porous layer and the heat-resistant adhesive porous layer, by the following criteria.

A: Strong adhesiveness (the adhesive surface of the adhesive tape being white, no peeling between the adhesive porous layer and the heat-resistant adhesive porous layer)

B: Sufficient adhesion (the adhesive surface of the adhesive tape being entirely black and partially having a white portion, the heat-resistant adhesive porous layer being slightly adhered on a part of the adhesive porous layer)

C: Weak adhesion (the adhesive surface of the adhesive tape being almost black, only the adhesive porous layer being peeled off)

[Adhesion Strength to Positive Electrode: Dry Heat Press]

89.5 g of lithium cobalt oxide powder as a positive electrode active material, 4.5 g of acetylene black as a conductive auxiliary agent, and 6 g of polyvinylidene fluoride as a binder were dissolved in N-methyl-pyrrolidone such a manner that the concentration of the polyvinylidene fluoride would be 6% by mass, and the resultant solution was stirred in a dual arm-type mixer to prepare a positive electrode slurry. The positive electrode slurry was applied to one surface of a 20 μm-thick aluminum foil, and dried, and pressing was then performed to obtain a positive electrode having a positive electrode active material layer.

The positive electrode obtained as described above was cut to a width of 1.5 cm and a length of 7 cm, and the separator was cut to a size of 1.8 cm in the TD direction and 7.5 cm in the MD direction. The positive electrode and the separator were superposed on each other, and hot-pressed under the condition of a temperature of 80° C., a pressure of 5.0 MPa, and a time of 3 minutes to adhere the positive electrode to the separator with each other, thereby obtaining a test piece. The separator was slightly peeled from the positive electrode at one end of the test piece in the length direction (i.e. MD direction of the separator), two separated end parts were held in Tensilon (RTC-1210A manufactured by Orientec Co., Ltd.), and a T-shape peeling test was conducted. The tension speed in the T-shape peeling test was set to 20 mm/min, and a load (N) in peeling of the separator from the positive electrode was measured, a load was measured at intervals of 0.4 mm up to 40 mm from 10 mm after the start of measurement, and an average thereof was calculated. Further, measured values for three test pieces were averaged, and the average was defined as a adhesion strength (N) of the separator.

[Adhesive Strength to Positive Electrode: Wet Heat Press]

The thus-obtained positive electrode was cut into a width of 1.5 cm and a length of 7 cm, the separator was cut into 1.8 cm in the TD direction, and 7.5 cm in the MD direction. The positive electrode and the separator were overlapped, and placed in the outer packaging material, and then the electrolyte solution (LiBF₄ of 1 mol %/L, EC/DEC/PC=33.3/33.3/33.3% by mass)) was injected thereinto, vacuum defoaming was repeated five times, a residual electrolyte solution was removed, and the outer packaging material was sealed, and then allowed to be left for 24 hours. The outer packaging material was hot-pressed under the condition of a temperature of 85° C., a pressure of 1.0 MPa, and a time of 15 seconds, and then the laminated body was taken out of the outer packaging material, the separator was slightly peeled off from the positive electrode on one end in a longitudinal direction of the specimen (that is, the MD direction of the separator), and the two separated ends were held in Tensilon (RTC-1210A manufactured by Orientec Co., Ltd.), and a T-shape peeling test was conducted. The tension speed in the T-shape peeling test was set to 20 mm/min, and a load (N) in peeling of the separator from the positive electrode was measured. A load was measured at intervals of 0.4 mm up to 40 mm from 10 mm after the start of measurement, and an average thereof was calculated, and the measured values of three specimens were further averaged, which was the adhesive strength (N).

[Adhesion Strength to Negative Electrode: Dry Heat Press]

300 g of artificial graphite as a negative electrode active material, 7.5 g of water-soluble dispersion liquid which contained 40% by mass of modified product of styrene-butadiene copolymer, as a binder, 3 g of carboxymethylcellulose as a thickener, and a proper amount of water were stirred in a dual arm-type mixer to prepare negative electrode slurry. The negative electrode slurry was applied to one surface of a 10 μm-thick copper foil, and dried, and pressing was then performed to obtain a negative electrode having a negative electrode active material layer.

Using the negative electrode obtained as described above, a T-shape peeling test was conducted in the same manner as described above in [Adhesion strength to Positive Electrode: Dry Heat Press] to determine a adhesion strength (N) of the separator.

[Adhesive Strength to Negative Electrode: Wet Heat Press]

Using the above-obtained negative electrode, the T-shape peeling test was conducted identically to [Adhesive strength to positive electrode: wet heat press], thereby determining the adhesive strength (N) of the separator.

[Thermal Shrinkage]

A separator was cut to 18 cm (MD direction)×6 cm (TD direction) to give a sample for measurement. On a line bisecting the TD direction, two points 2 cm and 17 cm from one end were marked (point A and point B). In addition, on a line bisecting the MD direction, two points 1 cm and 5 cm from one end were marked (point C and point D). A position within 2 cm of the upper part of MD direction of the sample was clipped. The sample was hung in an oven adjusted at 150° C., and heat-treated under no tension for 30 minutes. The lengths between A and B and between C and D were measured before and after the heat treatment. Thermal shrinkage (%) was calculated by the following equations.

Thermal shrinkage in the MD direction (%)=(length between A and B before heat treatment−length between A and B after heat treatment)/(length between A and B before heat treatment)×100

Thermal shrinkage in the TD direction (%)=(length between C and D before heat treatment−length between C and D after heat treatment)/(length between C and D before heat treatment)×100

[Cycle Characteristic (Capacity Retention Ratio)]

A lead tab was welded to the positive electrode and negative electrode, and the positive electrode, the separator, and the negative electrode were laminated in this order. The resulting laminated body was inserted into a pack made of an aluminum laminate film, the inside of the pack was brought into vacuum state and temporarily sealed using a vacuum sealer, and the pack was hot-pressed in the lamination direction of the laminated body using a hot-pressing machine, thereby adhering the electrodes and the separator to each other. As conditions for hot-pressing, the temperature was 90° C., the load per 1 cm² of electrode was 20 kg, and the pressing time was 2 minutes. Then, an electrolytic solution (1 mol/L LiPF₆-ethylene carbonate:ethylmethyl carbonate [mass ratio 3:7]) was injected into the pack, the laminated body was impregnated with the electrolytic solution, and the inside of the pack was brought into a vacuum state and sealed using a vacuum sealer, thereby obtaining a battery.

The battery was charged and discharged for 500 cycles under an environment at a temperature of 40° C. Charge was constant current and constant voltage charge at 1 C and 4.2 V, and discharge was constant current discharge of 1 C and a 2.75 V cutoff. A discharge capacity at the 500th cycle was divided by an initial capacity, an average for ten batteries was calculated, and the obtained value (%) was defined as a capacity retention ratio.

[Load Characteristic]

A battery was produced in the same manner as in production of a battery [Cycle Characteristic (Capacity Retention Ratio)]. The battery was charged and discharged under an environment at a temperature of 15° C., a discharge capacity in discharge at 0.2 C and a discharge capacity in discharge at 2 C were measured, the latter was divided by the former, an average for ten batteries was calculated, and the obtained value (%) was defined as a load characteristic. As charge conditions, constant current and constant voltage charge was performed at 0.2 C and 4.2 V for 8 hours, and as discharge conditions, constant current discharge was performed at a 2.75 V cutoff.

<Production of A: Separator>

### Example 1

CONEX® (manufactured by Teijin Techno Products Limited) which is the meta-wholly aromatic polyamide and the acrylic type resin (butyl acrylate-methyl methacrylate-styrene copolymer, a polymerization ratio [mass ratio] of 20:40:40, a weight average molecular weight of 32,000, a glass transition temperature of 60° C.) were dissolved in a mixed solvent of dimethylacetamide and tripropylene glycol (dimethylacetamide:tripropylene glycol=80:20 [mass ratio]) to prepare the coating liquid for forming a heat-resistant adhesive porous material. The mass ratio of the meta-wholly aromatic polyamide and the acrylic type resin contained in the coating liquid was 55:45, and the resin concentration of the coating liquid was 9.0% by mass. The obtained coating liquid was transparent.

The coating liquid was coated on both sides of a polyethylene microporous membrane (membrane thickness of 9.0 Gurley value of 150 sec/100 cc, porosity of 43%) which is the porous substrate (at this time, coated so that the coated amounts on the front and back sides are equal), and the coated membrane was immersed in the coagulation liquid (water:dimethylacetamide:tripropylene glycol=62.5:30:7.5 [mass ratio], a liquid temperature of 35° C.) to be solidified. Next, this was washed with water and dried, thereby obtaining the separator having the heat-resistant adhesive porous layers formed on both sides of the polyethylene microporous membrane. The drying temperature was 60° C. As a result of microscopic (SEM) observation, it was found that the heat-resistant adhesive porous layer had a structure in which the acrylic type resin having a particle configuration with a size of 80 nm is dispersed in the porous structure composed of the meta-wholly aromatic polyamide.

### Example 2

The separator was produced in the same manner as in Example 1, except that the acrylic type resin was changed to a tetrapolymer of butyl acrylate-methyl methacrylate-styrene-unsaturated carboxylic anhydride (a polymerization ratio [mass ratio] of 20:39:39:2, a weight average molecular weight of 35,000, a glass transition temperature of 61° C.). The obtained coating liquid was transparent. As a result of microscopic (SEM) observation of the separator, it was found that the heat-resistant adhesive porous layer had a structure in which the acrylic type resin having a particle configuration with a size of 78 nm is dispersed in the porous structure composed of the meta-wholly aromatic polyamide.

### Example 3

An aqueous emulsion (solid content concentration: 40% by mass, average particle size: 170 nm) composed of CONEX® (manufactured by Teijin Techno Products Limited) which is the meta-wholly aromatic polyamide and the acrylic type resin (a terpolymer of lauryl acrylate-ethylhexyl acrylate-styrene (a polymerization ratio [mass ratio] of 40:40:20, a weight average molecular weight of 65,000, a glass transition temperature of −18° C.), and 0.1% by mass of a water-soluble fluorine-based surfactant (SURFLON 5233, manufactured by AGC SEIMI CHEMICAL CO., LTD.) with respect to the coating liquid, were added to dimethylacetamide to prepare 8.2% by mass of the coating liquid. Except using this coating liquid, the separator was produced in the same manner as in Example 1. The obtained coating liquid was opaque since the acryl particles are insoluble in the coating liquid. As a result of microscopic observation of the separator, the acrylic type resin particles having an average particle size of 170 nm were not observed, the structure in which the surface of the porous structure composed of the meta-wholly aromatic polyamide is coated with the acrylic type resin was found.

### Example 4

The separator was produced in the same manner as in Example 1, except that CONEX® (manufactured by Teijin Techno Products Limited) which is the meta-wholly aromatic polyamide was changed to wholly aromatic polyamideimide (TORLON 4000TF, manufactured by Solvay S.A.). The obtained coating liquid was transparent. As a result of microscopic observation of the separator, it was found that the heat-resistant adhesive porous layer had a structure in which the acrylic type resin having a particle configuration with a size of 68 nm is dispersed in the porous structure composed of the wholly aromatic polyamideimide.

### Example 5

The separator was produced in the same manner as in Example 1, except that magnesium hydroxide particles (volume average particle diameter of primary particles of 0.8 BET specific surface area of 6.8 m²/g) were further dispersed in the coating liquid so as to have the content described in Table 1.

### Example 6

The separator was produced in the same manner as in Example 1, except that the porous substrate was changed to Celgard (a three-layer structure of polypropylene/polyethylene/polypropylene, a membrane thickness of 16.0 Gurley value of 185 sec/100 cc, porosity of 48%).

### Comparative Example 1

The separator was produced in the same manner as in Example 1, except that the coating liquid did not contain the acrylic type resin.

### Comparative Example 2

The separator was produced in the same manner as in Example 4, except that the coating liquid did not contain the acrylic type resin.

### Comparative Example 3

The separator was produced in the same manner as in Example 1, except that the coating liquid did not contain the heat-resistant resin.

### Comparative Example 4

The separator was produced in the same manner as in Example 1, except that the acrylic type resin in the coating liquid was changed to the polyvinylidene fluoride type resin (binary copolymer of VDF-HFP, a ratio of HFP unit of 5.1% by mass, a weight average molecular weight of 1,130,000). The coating liquid was whitely clouded.

### Comparative Example 5

The separator was produced in the same manner as in Example 4, except that the acrylic type resin in the coating liquid was changed to the polyvinylidene fluoride type resin (binary copolymer of VDF-HFP, a ratio of HFP unit of 5.1% by mass, a weight average molecular weight of 1,130,000). The coating liquid was whitely clouded.

TABLE 1

| | | | Example 1 | Example 2 | Example 3 | Example 4 | Example 5 | Example 6 |
|---|---|---|---|---|---|---|---|---|
| Heat | Heat-resistant resin | | Aramid | Aramid | Aramid | Polyam- | Aramid | Aramid |
| resistant | | | | | | ideimide | | |
| adhesive | Acrylic type | Acrylic type | 60 | 59 | 80 | 60 | 60 | 60 |
| porous layer | resin | monomer unit | | | | | | |
| | | content [% by mass] | | | | | | |
| | | Styrene type | 40 | 39 | 20 | 40 | 40 | 40 |
| | | monomer unit | | | | | | |
| | | content [% by mass] | | | | | | |
| | | Maleic anhydride | 0 | 2 | 0 | 0 | 0 | 0 |
| | | unit content [% by | | | | | | |
| | | mass] | | | | | | |
| | | Glass transition | 60 | 61 | −18 | 60 | 60 | 60 |
| | | temperature [° C.] | | | | | | |
| | Solid content | Heat-resistant resin | 55 | 55 | 60 | 55 | 44 | 55 |
| | [% by mass] | Acrylic type resin | 45 | 45 | 40 | 45 | 36 | 45 |
| | | PVDF type resin | — | — | — | — | — | — |
| | | Filler | — | — | — | — | 20 | — |
| | Layer thickness (one side) [μm] | | 1.5 | 1.5 | 1.5 | 1.5 | 1.5 | 3 |
| | Porosity [%] | | 57. | 56 | 48 | 53 | 57 | 54 |
| Physical | Membrane thickness [μm] | | 12 | 12 | 12 | 12 | 12 | 22 |
| properties of | Gurley value [sec/100 cc] | | 197 | 206 | 216 | 203 | 199 | 278 |
| separator | Peeling strength [N/10 mm] | | 0.21 | 0.24 | 0.28 | 0.22 | 0.25 | 0.48 |
| | Adhesiveness to adhesive porous | | B | B | B | B | B | B |
| | layer | | | | | | | |
| | Adhesive | Positive electrode | 0.05 | 0.06 | 0.08 | 0.04 | 0.02 | 0.09 |
| | strength to | Negative electrode | 0.12 | 0.13 | 0.15 | 0.12 | 0.08 | 0.16 |
| | electrode | | | | | | | |
| | [N] | | | | | | | |
| | Thermal | MD | 26 | 27 | 26 | 26 | 25 | 20 |
| | shrinkage | TD | 23 | 23 | 24 | 24 | 22 | 19 |
| | [%] | | | | | | | |

| | | | | | | | |
|---|---|---|---|---|---|---|---|
| Evaluation | Cycle characteristics [%] | 94 | 94 | 89 | 92 | 91 | 87 |
| of battery | Load characteristics [%] | 92 | 91 | 87 | 89 | 90 | 85 |

| | | | Comparative | Comparative | Comparative | Comparative | Comparative |
|---|---|---|---|---|---|---|---|
| | | | Example 1 | Example 2 | Example 3 | Example 4 | Example 5 |
| Heat | Heat-resistant resin | | Aramid | Polyam- | — | Aramid | Polyam- |
| resistant | | | | ideimide | | | ideimide |
| adhesive | Acrylic type | Acrylic type | — | — | 60 | — | — |
| porous layer | resin | monomer unit | | | | | |
| | | content [% by mass] | | | | | |
| | | Styrene type | — | — | 40 | — | — |
| | | monomer unit | | | | | |
| | | content [% by mass] | | | | | |
| | | Maleic anhydride | — | — | 0 | — | — |
| | | unit content [% by | | | | | |
| | | mass] | | | | | |
| | | Glass transition | — | — | 60 | — | — |
| | | temperature [° C.] | | | | | |
| | Solid content | Heat-resistant resin | 100 | 100 | — | 55 | 55 |
| | [% by mass] | Acrylic type resin | — | — | 100 | — | — |
| | | PVDF type resin | — | — | — | 45 | 45 |
| | | Filler | — | — | — | — | — |
| | Layer thickness (one side) [μm] | | 1.5 | 1.5 | 1.5 | 1.5 | 1.5 |
| | Porosity [%] | | 52 | 56 | 51 | 32 | 31 |
| Physical | Membrane thickness [μm] | | 12 | 12 | 12 | 12 | 12 |
| properties of | Gurley value [sec/100 cc] | | 204 | 208 | 215 | 348 | 367 |
| separator | Peeling strength [N/10 mm] | | 0.11 | 0.11 | 0.08 | 0.08 | 0.07 |
| | Adhesiveness to adhesive porous | | C | C | A | B | B |
| | layer | | | | | | |
| | Adhesive | Positive electrode | 0 | 0 | 0.05 | 0.07 | 0.06 |
| | strength to | Negative electrode | 0 | 0 | 0.07 | 0.02 | 0.03 |
| | electrode | | | | | | |
| | [N] | | | | | | |
| | Thermal | MD | 26 | 25 | 52 | 42 | 45 |
| | shrinkage | TD | 23 | 22 | 57 | 45 | 47 |
| | [%] | | | | | | |

| | | | | | | |
|---|---|---|---|---|---|---|
| Evaluation | Cycle characteristics [%] | 81 | 80 | 78 | 54 | 52 |
| of battery | Load characteristics [%] | 79 | 78 | 78 | 57 | 53 |

<Production of B: Separator>

### Example 7

CONEX® (manufactured by Teijin Techno Products Limited) which is the meta-wholly aromatic polyamide, the acrylic type resin (2-ethylhexyl acrylate-methyl methacrylate-styrene copolymer, a polymerization ratio [mass ratio] of 20:40:40, a weight average molecular weight of 32,000, a glass transition temperature of 45° C.), and polyvinylidene fluoride type resin (VDF-HFP copolymer, HFP unit content of 12.4% by mass, weight average molecular weight of 860,000) were dissolved in a mixed solvent of dimethylacetamide and tripropylene glycol (dimethylacetamide:tripropylene glycol=80:20 [mass ratio]) to prepare the coating liquid for forming a heat-resistant adhesive porous material. The mass ratio of the meta-wholly aromatic polyamide, the acrylic type resin, and the polyvinylidene fluoride type resin contained in the coating liquid was 41.7:33.3:25, and the resin concentration of the coating liquid was 4.0% by mass. The obtained coating liquid was transparent.

The coating liquid was coated on both sides of a polyethylene microporous membrane (membrane thickness of 9.0 μm, Gurley value of 150 sec/100 cc, porosity of 43%) which is the porous substrate (at this time, coated so that the coated amounts on the front and back surfaces are equal), and the coated membrane was immersed in the coagulation liquid (water:dimethylacetamide:tripropylene glycol=62.5:30:7.5 [mass ratio], a liquid temperature of 35° C.) to be solidified. Next, this was washed with water and dried, thereby obtaining the separator having the heat-resistant adhesive porous layers formed on both sides of the polyethylene microporous membrane. The drying temperature was 60° C. As a result of microscopic (SEM) observation, it was found that the heat-resistant adhesive porous layer had a structure in which a mixture having a particle configuration with a size of 70 nm and composed of the acrylic type resin and the polyvinylidene fluoride type resin is dispersed in the porous structure composed of the meta-wholly aromatic polyamide.

### Example 8

The separator was produced in the same manner as in Example 7, except that the mass ratio of the meta-wholly aromatic polyamide, the acrylic type resin and the polyvinylidene fluoride type resin was changed to 62.5:25:12.5. The obtained coating liquid was transparent. As a result of microscopic (SEM) observation of the separator, it was found that the heat-resistant adhesive porous layer had a structure in which a mixture of the acrylic type resin having a particle configuration with a size of 75 nm and the polyvinylidene fluoride type resin is dispersed in the porous structure composed of the meta-wholly aromatic polyamide.

### Example 9

The separator was produced in the same manner as in Example 7, except that the acrylic type resin was changed to a tetrapolymer of butyl acrylate-methyl methacrylate-styrene-unsaturated carboxylic anhydride (a polymerization ratio [mass ratio] of 20:39:39:2, a weight average molecular weight of 35,000, a glass transition temperature of 61° C.). The obtained coating liquid was transparent. As a result of microscopic (SEM) observation of the separator, it was found that the heat-resistant adhesive porous layer had a structure in which a mixture having a particle configuration with a size of 83 nm and composed of the acrylic type resin and the polyvinylidene fluoride type resin is dispersed in the porous structure composed of the meta-wholly aromatic polyamide.

### Example 10

The separator was produced in the same manner as in Example 7, except that the acrylic type resin was changed to a binary copolymer of 2-ethylhexyl acrylate-methyl methacrylate (a polymerization ratio [mass ratio] of 60:40, a weight average molecular weight of 51,000, a glass transition temperature of −25° C.), and the mass ratio of the meta-wholly aromatic polyamide and the acrylic type resin, the acrylic type resin, and the polyvinylidene fluoride type resin was changed to 62.5:25:12.5. The obtained coating liquid was transparent. As a result of microscopic (SEM) observation of the separator, particles made of the mixture of the acrylic type resin and the polyvinylidene fluoride type resin were not found, and the structure in which the surface of the porous structure composed of the meta-wholly aromatic polyamide is coated with the mixture was found.

### Example 11

The separator was produced in the same manner as in Example 7, except that CONEX® (manufactured by Teijin Techno Products Limited) which is the meta-wholly aromatic polyamide was changed to wholly aromatic polyamideimide (TORLON 4000TF, manufactured by Solvay S.A.). The obtained coating liquid was transparent. As a result of microscopic (SEM) observation of the separator, the heat-resistant adhesive porous layer had a structure in which the mixture having a particle configuration with a size of 64 nm and composed of the acrylic type resin and the polyvinylidene fluoride type resin is dispersed in the porous structure composed of the wholly aromatic polyamideimide.

### Example 12

The separator was produced in the same manner as in Example 7, except that magnesium hydroxide particles (volume average particle diameter of primary particles of 0.8 BET specific surface area of 6.8 m²/g) were further dispersed in the solution so as to have the content described in Table 2.

### Example 13

The separator was produced in the same manner as in Example 7, except that the porous substrate was changed to Celgard (a three-layer structure of polypropylene/polyethylene/polypropylene, a membrane thickness of 16.0 Gurley value of 185 sec/100 cc, porosity of 48%). The obtained coating liquid was transparent.

### Reference Example 1

The separator was produced in the same manner as in Example 7, except that the coating liquid did not contain the polyvinylidene fluoride type resin, the acrylic type resin was changed to a butyl acrylate-methyl methacrylate-styrene copolymer (a polymerization ratio [mass ratio] of 20:40:40, a weight average molecular weight of 32,000, a glass transition temperature of 60° C.), and the content was changed to be those described in Table 2. The obtained coating liquid was transparent.

TABLE 2

| | | | Exam- | Exam- | Exam- | Exam- | Exam- | Exam- | Exam- | Reference |
|---|---|---|---|---|---|---|---|---|---|---|
| | | | ple 7 | ple 8 | ple 9 | ple 10 | ple 11 | ple 12 | ple 13 | Example 1 |
| Heat- | Heat-resistant resin | | Aramid | Aramid | Aramid | Aramid | Polyam- | Aramid | Aramid | Aramid |
| resistant | | | | | | | ideimide | | | |
| adhesive | Acrylic type | Acrylic type | 60 | 60 | 59 | 100 | 60 | 60 | 60 | 60 |
| porous | resin | monomer unit | | | | | | | | |
| layer | | content [% by | | | | | | | | |
| | | mass] | | | | | | | | |
| | | Styrene type | 40 | 40 | 39 | 0 | 40 | 40 | 40 | 40 |
| | | monomer unit | | | | | | | | |
| | | content [% by | | | | | | | | |
| | | mass] | | | | | | | | |
| | | Maleic anhydride | 0 | 0 | 2 | 0 | 0 | 0 | 0 | 0 |
| | | unit content [% by | | | | | | | | |
| | | mass] | | | | | | | | |
| | | Glass transition | 45 | 45 | 61 | −25 | 45 | 45 | 45 | 60 |
| | | temperature [° C.] | | | | | | | | |
| | Solid content | Heat-resistant resin | 41.7 | 62.5 | 41.7 | 62.5 | 41.7 | 16.7 | 41.7 | 55 |
| | [% by mass] | Acrylic type resin | 33.3 | 25 | 33.3 | 25 | 33.3 | 13.3 | 33.3 | 45 |
| | | PVDF type resin | 25 | 12.5 | 25 | 12.5 | 25 | 10 | 25 | — |
| | | Filler | — | — | — | — | — | 60 | — | — |
| | Layer thickness (one side) [μm] | | 1.5 | 1.5 | 1.5 | 1.5 | 1.5 | 1.5 | 3 | 1.5 |
| | Porosity [%] | | 55 | 53 | 54 | 55 | 52 | 58 | 54 | 57 |
| Physical | Membrane thickness [μm] | | 12 | 12 | 12 | 12 | 12 | 12 | 22 | 12 |
| properties of | Gurley value [sec/100 cc] | | 198 | 201 | 197 | 199 | 203 | 194 | 271 | 197 |
| separator | Peeling strength [N/10 mm] | | 0.26 | 0.25 | 0.24 | 0.21 | 0.18 | 0.19 | 0.42 | 0.21 |
| | Adhesiveness to adhesive porous | | A | A | A | A | A | A | A | B |
| | layer | | | | | | | | | |
| | Dry adhesive | Positive electrode | 0.24 | 0.21 | 0.26 | 0.31 | 0.23 | 0.15 | 0.24 | 0.05 |
| | strength to | Negative electrode | 0.27 | 0.25 | 0.29 | 0.35 | 0.26 | 0.14 | 0.27 | 0.12 |
| | electrode [N] | | | | | | | | | |
| | Wet adhesive | Positive electrode | 0.035 | 0.033 | 0.038 | 0.041 | 0.031 | 0.018 | 0.034 | 0.003 |
| | strength to | Negative electrode | 0.026 | 0.023 | 0.025 | 0.033 | 0.022 | 0.013 | 0.025 | 0.005 |
| | electrode [N] | | | | | | | | | |
| | Thermal | MD | 33 | 29 | 32 | 29 | 27 | 27 | 25 | 26 |
| | shrinkage [%] | TD | 30 | 28 | 30 | 27 | 26 | 26 | 22 | 23 |

| | | | | | | | | | |
|---|---|---|---|---|---|---|---|---|---|
| Evaluation | Cycle characteristics [%] | 93 | 93 | 93 | 92 | 91 | 92 | 88 | 94 |
| of battery | Load characteristics [%] | 91 | 90 | 90 | 91 | 88 | 90 | 86 | 92 |

<Production of C: Separator>

### Example 14

TECHNORA® (manufactured by Teijin Techno Products Limited) which is the para-wholly aromatic polyamide and the acrylic type resin (a butyl acrylate-methyl methacrylate-styrene copolymer, a polymerization ratio [mass ratio] of 20:40:40, a weight average molecular weight of 32,000, a glass transition temperature of 60° C.) were dissolved in a mixed solvent of dimethylacetamide, tripropylene glycol and calcium chloride (dimethylacetamide:tripropylene glycol:calcium chloride=87.3:9.7:3 [mass ratio]) to prepare the coating liquid for forming a heat-resistant adhesive porous material. The mass ratio of the para-wholly aromatic polyamide and the acrylic type resin contained in the coating liquid was 55:45, and the resin concentration of the coating liquid was 2.0% by mass. The obtained coating liquid was transparent.

The coating liquid was coated on both sides of a polyethylene microporous membrane (membrane thickness of 9.0 Gurley value of 150 sec/100 cc, porosity of 43%) which is the porous substrate (at this time, coated so that the coated amounts on the front and back surfaces are equal), and the coated membrane was immersed in the coagulation liquid (water:dimethylacetamide:tripropylene glycol=62.5:30:7.5 [mass ratio], a liquid temperature of 35° C.) to be solidified. Next, this was washed with water and dried, thereby obtaining the separator having the heat-resistant adhesive porous layers formed on both sides of the polyethylene microporous membrane. The drying temperature was 60° C. As a result of microscopic (SEM) observation, it was found that the heat-resistant adhesive porous layer had a structure in which the acrylic type resin having a particle configuration with a size of 83 nm is dispersed in the porous structure composed of the para-wholly aromatic polyamide.

### Example 15

TECHNORA® (manufactured by Teijin Techno Products Limited) which is the para-wholly aromatic polyamide, the acrylic type resin (2-ethylhexyl acrylate-methyl methacrylate-styrene copolymer, a polymerization ratio [mass ratio] of 20:40:40, a weight average molecular weight of 32,000, a glass transition temperature of 45° C.), and the polyvinylidene fluoride type resin (a VDF-HFP copolymer, a HFP unit content of 12.4% by mass, a weight average molecular weight of 860,000) were dissolved in a mixed solvent of dimethylacetamide, tripropylene glycol and calcium chloride (dimethylacetamide:tripropylene glycol:calcium chloride=87.3:9.7:3 [mass ratio]) to prepare the coating liquid for forming a heat-resistant adhesive porous material. The mass ratio of the para-wholly aromatic polyamide, the acrylic type resin and the polyvinylidene fluoride type resin contained in the coating liquid was 41.7:33.3:25, and the resin concentration of the coating liquid was 2.0% by mass. The obtained coating liquid was transparent.

The coating liquid was coated on both sides of a polyethylene microporous membrane (membrane thickness of 9.0 Gurley value of 150 sec/100 cc, porosity of 43%) which is the porous substrate (at this time, coated so that the coated amounts on the front and back sides are equal), and the coated membrane was immersed in the coagulation liquid (water:dimethylacetamide:tripropylene glycol=62.5:30:7.5 [mass ratio], a liquid temperature of 35° C.) to be solidified. Next, this was washed with water and dried, thereby obtaining the separator having the heat-resistant adhesive porous layers formed on both sides of the polyethylene microporous membrane. The drying temperature was 60° C. As a result of microscopic (SEM) observation, it was found that the heat-resistant adhesive porous layer had a structure in which the mixture having a particle configuration with a size of 75 nm and composed of the acrylic type resin and the fluorine-based vinylidene resin is dispersed in the porous structure composed of the para-wholly aromatic polyamide.

### Example 16

The separator was produced in the same manner as in Example 15, except that magnesium hydroxide particles (a volume average particle diameter of primary particles of 0.8 μm, a BET specific surface area of 6.8 m²/g) were further dispersed in the coating liquid so as to have the content described in Table 3.

### Comparative Example 6

The separator was produced in the same manner as in Example 14, except that the coating liquid did not contain the acrylic type resin.

TABLE 3

| | | | | | | Comparative |
|---|---|---|---|---|---|---|
| | | | Example 14 | Example 15 | Example 16 | Example 6 |
| Heat-resistant | Acrylic type resin | Acrylic type monomer | 60 | 60 | 60 | — |
| adhesive porous | | unit content [% by | | | | |
| layer | | mass] | | | | |
| | | Styrene type | 40 | 40 | 40 | — |
| | | monomer unit content | | | | |
| | | [% by mass] | | | | |
| | | Glass transition | 60 | 45 | 45 | — |
| | | temperature [° C.] | | | | |
| | Solid content | Para-wholly aromatic | 55 | 41.7 | 16.7 | 100 |
| | [% by mass] | polyamide | | | | |
| | | Acrylic type resin | 45 | 33.3 | 13.3 | — |
| | | PVDF type resin | — | 25 | 10 | — |
| | | Filler | — | — | 60 | — |
| | Layer thickness (one side) [μm] | | 1.5 | 1.5 | 1.5 | 1.5 |
| | Porosity [%] | | 48 | 53 | 56 | 5 |
| Physical | Membrane thickness [μm] | | 12 | 12 | 12 | 12 |
| properties of | Gurley value [sec/100 cc] | | 218 | 199 | 196 | 32500 |
| separator | Peeling strength [N/10 mm] | | 0.22 | 0.25 | 0.23 | 0.21 |
| | Dry adhesive strength | Positive electrode | 0.06 | 0.24 | 0.19 | 0 |
| | to electrode [N] | Negative electrode | 0.13 | 0.28 | 0.16 | 0 |
| | Wet adhesive strength | Positive electrode | 0.004 | 0.036 | 0.019 | 0 |
| | to electrode [N] | Negative electrode | 0.006 | 0.028 | 0.015 | 0 |
| | Thermal shrinkage [%] | MD | 23 | 30 | 25 | 21 |
| | | TD | 210 | 27 | 24 | 22 |

| | | | | | |
|---|---|---|---|---|---|
| Evaluation | Cycle characteristics [%] | 94 | 93 | 93 | 5 |
| of battery | Load characteristics [%] | 92 | 91 | 90 | 3 |

What is claimed is:

1. A separator for a non-aqueous secondary battery that is composed of a composite membrane, the composite membrane comprising:
a porous substrate, and
a heat-resistant adhesive porous layer provided on one side or both sides of the porous substrate, wherein
the heat-resistant adhesive porous layer contains an acrylic type resin, and a heat-resistant resin that has a glass transition temperature of 200° C. or more and that has an amide-structure.

2. The separator for a non-aqueous secondary battery according to claim 1, wherein the heat-resistant adhesive porous layer has a structure in which the acrylic type resin having a particle configuration with a size of from 10 nm to 500 nm is dispersed in a porous structure of the heat-resistant resin.

3. The separator for a non-aqueous secondary battery according to claim 2, wherein a glass transition temperature of the acrylic type resin is from 0° C. to 80° C.

4. The separator for a non-aqueous secondary battery according to claim 1, wherein the heat-resistant adhesive porous layer has a structure in which a surface of the porous structure of the heat-resistant resin and/or inside surface of pores of the porous structure of the heat-resistant resin is coated with the acrylic type resin.

5. The separator for a non-aqueous secondary battery according to claim 4, wherein a glass transition temperature of the acrylic type resin is less than 0° C.

6. The separator for a non-aqueous secondary battery according to claim 1, wherein the heat-resistant resin is one or more selected from the group consisting of a polyamide imide, a wholly aromatic polyamide, a poly-N-vinylacetamide, a polyacrylamide and a polyetheramide copolymer.

7. The separator for a non-aqueous secondary battery according to claim 1, wherein the heat-resistant resin is a para-wholly aromatic polyamide.

8. The separator for a non-aqueous secondary battery according to claim 1, wherein a content of the acrylic type resin in the heat-resistant adhesive porous layer is from 5 to 60% by mass with respect to a total mass of the acrylic type resin and the heat-resistant resin.

9. The separator for a non-aqueous secondary battery according to claim 1, wherein the heat-resistant adhesive porous layer further contains a polyvinylidene fluoride type resin.

10. The separator for a non-aqueous secondary battery according to claim 9, wherein the heat-resistant resin is one or more selected from the group consisting of a polyamide imide, a wholly aromatic polyamide, a poly-N-vinylacetamide, a polyacrylamide and a polyetheramide copolymer.

11. The separator for a non-aqueous secondary battery according to claim 9, wherein the heat-resistant resin is a para-wholly aromatic polyamide.

12. The separator for a non-aqueous secondary battery according to claim 9, wherein the acrylic type resin is a copolymer containing an acrylic type monomer and a styrene type monomer as monomer components.

13. The separator for a non-aqueous secondary battery according to claim 9, wherein the polyvinylidene fluoride type resin is a copolymer containing vinylidene fluoride and hexafluoropropylene as monomer components, a content of the hexafluoropropylene monomer component in the copolymer is from 3 to 20% by mass, and a weight average molecular weight of the copolymer is from 100,000 to 1,500,000.

14. The separator for a non-aqueous secondary battery according to claim 9, wherein a content of the polyvinylidene fluoride type resin in the heat-resistant adhesive porous layer is from 5 to 55% by mass with respect to a total mass of the acrylic type resin and the polyvinylidene fluoride type resin.

15. The separator for a non-aqueous secondary battery according to claim 9, wherein, in the heat-resistant adhesive porous layer, a content of the heat-resistant resin is from 30 to 80% by mass, a content of the acrylic type resin is from 10 to 40% by mass, and a content of the polyvinylidene fluoride type resin is from 10 to 30% by mass, with respect to a total mass of the heat-resistant resin, the acrylic type resin and the polyvinylidene fluoride type resin.

16. The separator for a non-aqueous secondary battery according to claim 9, wherein the heat-resistant adhesive porous layer has a structure in which a mixture that has a particle configuration with a size of from 10 nm to 500 nm and that is composed of the acrylic type resin and the polyvinylidene fluoride type resin is dispersed in a porous structure of the heat-resistant resin.

17. The separator for a non-aqueous secondary battery according to claim 9, wherein the heat-resistant adhesive porous layer has a structure in which a surface of the porous structure of the heat-resistant resin and/or inside surface of pores of the porous structure of the heat-resistant resin is coated with a mixture of the acrylic type resin and the polyvinylidene fluoride type resin.

18. The separator for a non-aqueous secondary battery according to claim 1, wherein the heat-resistant adhesive porous layer contains a filler in an amount of from 5 to 80% by mass with respect to a total mass of the heat-resistant adhesive porous layer.

19. The separator for a non-aqueous secondary battery according to claim 1, wherein an adhesive porous layer containing a polyvinylidene fluoride type resin is further provided on one side or both sides of the composite membrane.

20. A non-aqueous secondary battery, comprising:
a positive electrode,
a negative electrode, and
the separator for a non-aqueous secondary battery according to claim 1, disposed between the positive electrode and the negative electrode, wherein an electromotive force is obtained by lithium doping and dedoping.
